(19) United States
(12) Patent Application Publication
(10) Pub. No.: US 2024/0315489 A1
(43) Pub. Date: Sep. 26, 2024

(54) SYSTEM AND METHODS FOR BLENDERS WITH SERVING LID OR CUP

(71) Applicant: VITA-MIX MANAGEMENT CORPORATION, Olmsted Township, OH (US)

(72) Inventors: Jack Warren Gee II, Olmsted Township, OH (US); David Kolar, Olmsted Township, OH (US); Matt Mrakovich, Olmsted Township, OH (US); Saifur Tareen, Olmsted Township, OH (US)

(73) Assignee: VITA-MIX MANAGEMENT CORPORATION, Olmsted Township, OH (US)

(21) Appl. No.: 18/579,037

(22) PCT Filed: Jul. 14, 2022
(86) PCT No.: PCT/US2022/037107

§ 371 Date: Jan. 12, 2024

Related U.S. Application Data
(60) Provisional application No. 63/221,680, filed on Jul. 14, 2021.

(51) Int. Cl. A47J 43/07

(52) U.S. Cl. CPC A47J 43/0727

(57) ABSTRACT

A blending container may comprise a body forming a cavity. The body may comprise a closed end having a blade assembly, wherein the closed end is configured to operatively couple to a motor base. The blending container may also comprise an open end opposite the closed end, that comprises a perimeter edge defining an opening, wherein at least a portion of the perimeter edge is configured to operatively receive a serving lid or serving cup when the closed end is operatively coupled to the motor base.

### CROSS REFERENCE TO RELATED APPLICATIONS

This application claims priority to U.S. Patent Application Ser. No. 63/221,680 filed on Jul. 14, 2021 and entitled “System and Methods for Blenders with Serving Lid or Cup,” which is incorporated herein by reference.

### TECHNICAL FIELD

The present teachings relate to a blending system, and more particularly to a dual purpose blender and consumer lid or cup that is utilized during the blending process and that is deliverable to a consumer.

### BACKGROUND

Blenders and blending systems are often used to blend and process foodstuffs. Conventional blenders generally include a base with a motor and a mixing container with an operable mixing blade disposed therein. A blender lid is adapted to cover the mixing container. A user inserts contents within the mixing container to be mixed by the rotation of the blade. The container is positioned on the base as a user controls the operation of the motor within the base to rotate the mixing blade within the container to mix the contents therein.

Frozen, frosty, or icy drinks have become increasingly popular. Such drinks include the traditional shakes, and the more recently popular smoothies. Shakes, or milkshakes, are typically formed of ice cream and/or milk, and flavored as desired, with or without additives, such as candies, chocolates, peanut butter, fruits, etc. Milkshakes typically are available at most fast-food restaurants, such as burger chains, and may be made by special machines, or hand-made using mixers. Smoothies tend to be healthier, and may be formed of ice, frozen yogurt, and/or sorbet. Smoothies may include additives such as fruits, fruit juice, vegetables, vitamins, supplements, etc. Smoothies typically are available from specialty chains or juice bars, and may be made with a commercial or restaurant-grade blender. Such drinks also may be made at home, using a personal blender. Soups, salsas, sauces, purees, nut or oat milks, and the like, may also be made using a blender or blending systems.

In commercial kitchens, restaurants, and cafes, for example, and other businesses that make recipe-based food products, speed and accuracy in preparing such products is highly desirable. Time and precision are very important, and the time it takes from an order being placed to an order being complete, and the correctness of that order, can determine a customer's satisfaction and how many customers can be served. This may also affect profits. For frozen or blended products, as an example, workers must take time to add ingredients to the container based on a customer order or recipe, blend the ingredients, and then clean the container and lid. Such orders or recipes may be complex, and every step of the process, including time for cleaning, adds more time to the process. Additionally, these businesses often prepare different orders in succession and prepare individual batches based on a singular customer orders. As a result, cleaning of the blender or blending system, including the container and lid, may need to occur prior to another order being made. These businesses may also use blending systems and blending containers more often than other users, including, for example, nearly every order or a majority of orders.

Therefore, a need exists for improved blender systems. A need exists for blender systems that streamline the process of making and delivering an order to a customer. Moreover, there is a need for blender systems that require less cleaning or that require less downtime between preparing different orders.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Disclosed herein is a blending system comprising a consumer lid or cup that is utilized during the blending process as a cover to a blender container and that is thereafter deliverable to a consumer. The container may be sized and shaped to accommodate, as a cover of the container, an interior circumference or an edge circumference of a consumer lid, cup, bowl, mug or the like. In an example, a consumer cup may be inverted and placed onto the container to serve as a lid for the container during the blending process. A blender container attachment or adaptor may also be used to facilitate the interaction and fluid seal between the container and the consumer lid or cup. The consumer lid or cup may serve as the cover of the container during the blending of foodstuff and may contain the blended product within the container during the blending process. After blending, the consumer lid or cup, just used on the blender container, may then be used as the lid or cup that is presented or given to the consumer and that houses the blended foodstuff for consumption by the consumer.

Disclosed is a blending container. In an embodiment, the blending container may comprise a body forming a cavity. The body may include a closed end including a blade assembly, wherein the closed end is configured to operatively couple to a motor base. The body may include an open end opposite the closed end, and including a perimeter edge defining an opening. In an embodiment, at least a portion of the perimeter edge may be configured to operatively receive a serving lid or serving cup when the closed end is operatively coupled to the motor base.

In an embodiment, the perimeter edge of the open end may further include a lip configured to operatively mate with the serving lid or serving cup. In an embodiment, the lip may be configured to operatively form a snap-fit or friction fit with the serving lid or serving cup. In an embodiment, the lip may extend annularly from the opening for a predetermined width. In an embodiment, the lip may be configured to operatively receive a rim of the serving lid or serving cup when the serving cup is inverted. In an embodiment, the lip may further include a terminal end extending generally coaxially with the body.

In an embodiment, the open end may include a neck disposed between the open end and the closed end. In an embodiment, the body may taper inwardly towards the neck from the closed end. In an embodiment, an outer surface of the neck may be configured to operatively engage with the serving lid or serving cup.

In an embodiment, the body may further include at least two generally symmetrical sides, and at least one non-symmetrical side. In an embodiment, the sides of the at least two generally symmetrical sides and the at least one non-symmetrical side may be bound by one or more ribs extending from the closed end to the open end. In an embodiment, the blending container may further comprise a handle extending from the at least one non-symmetrical side. In an embodiment, the at least one non-symmetrical side may be generally planar. In an embodiment, the at least one non-symmetrical side may comprise a first arc having a first radius, and the at least two generally symmetrical sides may comprise a second arc having a second radius. In an embodiment, the first radius may be smaller than the second radius.

Disclosed is a blending container. In an embodiment, the blending container may comprise a body forming a cavity, and comprising a bottom wall defining a closed end, an open end defining an opening, and at least one side wall extending from the closed end to the open end. In an embodiment, the bottom wall may be couplable to a blade assembly and configured to operatively couple to a motor base. In an embodiment, a perimeter of the bottom wall may have a perimeter larger than a portion of the body between the open end and the closed end. In an embodiment, the open end may include a surface for receiving at least one of a serving cup lid or an inverted serving cup.

In an embodiment, the blending container may not include a lid. In an embodiment, the blending container may not include a lid or cover other than the serving cup lid or the inverted serving cup. In an embodiment, the open end of the blending container may further include a lip configured to operatively mate at least one of the serving cup lid or the inverted serving cup. In an embodiment, the lip may extend annularly from the opening for a predetermined width.

In an embodiment, the blending container may be configured to insert into an enclosure and carry out a blending operation without the serving cup lid or the inverted serving cup. In an embodiment, the surface of the open end may be configured to operatively receive varying sizes of serving lids or inverted serving cups.

Disclosed is a blending system. In an embodiment, the blending system may comprise a motor base, a container including a body forming a cavity and configured to operatively couple to the motor base at a closed end of the container, the closed end further including a blade assembly, wherein the container includes an open end opposite the closed end and is configured to receive foodstuff into the cavity. In an embodiment, the blending system may further comprise a serving cup or serving lid configured to operatively couple with the open end of the container, wherein the open end of the container is configured to be partially or fully covered by the serving lid or serving cup during blending of foodstuff.

Disclosed is a method for using a blending system and serving blended foodstuff. The method may comprise: inserting foodstuff into a blending container through an open end of the blending container; covering at least a portion of the open end of the blending container with a serving cup or an enclosure; actuating the blending system and blending the foodstuff; and transferring the blended foodstuff from the blending container into the serving cup.

In an embodiment, the method may further include removing the serving cup from the open end of the blending container prior to transferring the blended foodstuff from the blending container into the serving cup. In an embodiment, the method may further include rotating the blending container and the serving cup to transfer the blended foodstuff from the blending container into the serving cup.

These and other features and advantages of the present disclosure are set forth in the following specification, drawings and claims.

### DESCRIPTION OF THE DRAWINGS

The present teachings may be better understood by reference to the following detailed description taken in connection with the following illustrations, wherein:

FIG. 1 is a front view of a blending system including a base, container, and conventional cover in accordance with various disclosed aspects herein;

FIGS. 2A and B are front views of a blending system including a base, container, and conventional hinged cover in accordance with various disclosed aspects herein;

FIG. 3 is a front view of an embodiment of a container for a blending system in accordance with various disclosed aspects herein;

FIG. 4 is a front view of an embodiment of a container for a blending system in accordance with various disclosed aspects herein;

FIG. 5 is a front view of an embodiment of a container for a blending system in accordance with various disclosed aspects herein;

FIG. 6 is a front view of an embodiment of a serving or consumer cup for a blending system in accordance with various disclosed aspects herein;

FIG. 7 is a front view of an embodiment of a serving or consumer lid for a blending system in accordance with various disclosed aspects herein;

FIG. 8 is a front view of the container of FIG. 5 operatively coupled with the serving or consumer cup of FIG. 6 in accordance with various disclosed aspects herein;

FIG. 9 is a front view of the container of FIG. 5 operatively coupled with the serving or consumer lid of FIG. 7 in accordance with various disclosed aspects herein;

FIG. 10 is a front view of an embodiment of a container adapter for a serving or consumer lid for a blending system in accordance with various disclosed aspects herein;

FIG. 11 is a perspective view of the container adaptor of FIG. 10 operatively coupled to the container of FIGS. 2A and 2B in accordance with various disclosed aspects herein;

FIG. 12 is a front view of an embodiment of a container adaptor for a serving or consumer lid as attached to a container in accordance with various disclosed aspects herein;

FIG. 13 is a front view of an embodiment of a container adapter for a serving or consumer lid as attached to a container in accordance with various disclosed aspects herein;

FIG. 14 is a perspective view of an embodiment of a container operatively coupled with an embodiment of serving or consumer cup in accordance with various disclosed aspects herein;

FIG. 15 is a perspective view the container and operatively coupled serving or consumer cup of FIG. 14 placed in a blending housing or enclosure in accordance with various disclosed aspects herein;

FIG. 16 is a perspective view of an embodiment of a container for a blending system in accordance with various disclosed aspects herein;

FIG. 17 is a perspective view of an embodiment of a container for a blending system in accordance with various disclosed aspects herein;

FIG. 18 is a cross-sectional view of an embodiment of a container for a blending system in accordance with various disclosed aspects herein;

FIG. 19 is a perspective view of an embodiment of a container for a blending system in accordance with various disclosed aspects herein;

FIG. 20 is a perspective view of an embodiment of a container for a blending system in accordance with various disclosed aspects herein;

FIG. 21 is a perspective view of an embodiment of a container for a blending system in accordance with various disclosed aspects herein;

FIG. 22 is a perspective view of an embodiment of a container for a blending system in accordance with various disclosed aspects herein;

FIG. 23 is a cross-sectional view of an embodiment of a container for a blending system in accordance with various disclosed aspects herein;

FIG. 24 is a cross-sectional view of an embodiment of a container for a blending system in accordance with various disclosed aspects herein;

FIG. 25 is a perspective, cross-sectional view of an embodiment of a container for a blending system in accordance with various disclosed aspects herein;

FIG. 26 is a top view of an embodiment of a container for a blending system in accordance with various disclosed aspects herein;

FIG. 27 is a cross-sectional view of an embodiment of a container for a blending system in accordance with various disclosed aspects herein;

FIG. 28 is a perspective, cross-sectional view of an embodiment of a container for a blending system in accordance with various disclosed aspects herein;

FIG. 29 is a top view of an embodiment of a container for a blending system in accordance with various disclosed aspects herein;

FIG. 30 is a cross-sectional view of an embodiment of a container for a blending system in accordance with various disclosed aspects herein;

FIG. 31 is a perspective, cross-sectional view of an embodiment of a container for a blending system in accordance with various disclosed aspects herein;

FIG. 32 is a top view of an embodiment of a container for a blending system in accordance with various disclosed aspects herein;

FIG. 33 is a perspective, cross-sectional view of an embodiment of a container for a blending system in accordance with various disclosed aspects herein;

FIG. 34 is a cross-sectional view of an embodiment of a container for a blending system in accordance with various disclosed aspects herein; and

FIG. 35 is a perspective, cross-sectional view of an embodiment of a container for a blending system in accordance with various disclosed aspects herein;

FIG. 36 is a cross-sectional view of an embodiment of a container for a blending system in accordance with various disclosed aspects herein.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to embodiments of the present teachings, examples of which are illustrated in the accompanying drawings. It is to be understood that other embodiments may be utilized, and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

It is noted that references to a blender, blender system, and the like, are understood to include food processor systems, and other mixing systems. Such systems generally include a blender base that may include a motor, a blade assembly, and a controller. Further, such systems may include a container, a display, a memory and/or a processor. A blade assembly, a blending container, and a blender base may removably or irremovably attach. The blending system may be powered in any appropriate manner, such as disclosed in U.S. patent application Ser. No. 14/213,557, entitled Powered Blending Container, which is hereby incorporated by reference.

Furthermore, while blending of “ingredients,” “contents,” or “foodstuffs” is described by various embodiments, it is noted that non-food stuff may be mixed or blended, such as paints, epoxies, construction material (e.g., mortar, cement, etc.), and the like. Moreover, blending of ingredients may result in a blended product. Such blended products may include drinks, frozen drinks, smoothies, shakes, soups, purees, sorbets, butter (nut), dips or the like. Accordingly, such terms may be used interchangeably unless context suggests otherwise or warrants a particular distinction among such terms. Further, such terms are not intended to limit possible blended products and should be viewed as examples of possible blended products.

In embodiments, the blending systems may include any household blender and/or any type of commercial blending system, including those with covers that may encapsulate or partially encapsulate the blender. Commercial blending systems may include an overall blending system, such as a modular blending system that may include the blender along with other components, such as a cleaner, foodstuff storage device (including a refrigerator), an ice maker and/or dispenser, a foodstuff dispenser (a liquid or powder flavoring dispenser) or any other combination of such.

As used herein, the phrases “blending process,” “blending program,” and the like are used interchangeably unless context suggest otherwise or warrants a particular distinction among such terms. A blending process may comprise a series or sequence of blender settings and operations to be carried out by the blending device. In an aspect, a blending process may comprise at least one motor speed and at least one time interval for the given motor speed. For example, a blending process may comprise a series of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

Embodiments described herein may refer to single serving containers. A “single serving” container does not indicate a limited use for the container, but rather refers to a differently configured container that may be attached to a blade base. Such containers may have a closed end that is generally distal from a blender base when the container, blade base, and blender base are interlocked. The container may be any desired shape, such as a cup, bowl, pitcher, or the like. A user, for example, places foodstuff in the container and then attaches a blade base to the container. When operatively attached, the container and attached blade base are inverted and placed on a blender base. The blender base may then drive a blade assembly of the blade base.

In some traditional systems, containers are made of plastic materials. A blade assembly is attached to the container and a blender base drives the blade assembly with a motor. The parameters of the motor (e.g., speed, torque, etc.) may be constrained to limit or reduce the wear or strain on the container. In other examples, the motor may be allowed to operate at different parameters and the life expectancy of the container may be decreased relative to systems that limit the motor parameters.

Moreover, traditional blade assemblies can include blades that are not balanced or are otherwise asymmetric. For instance, a blade assembly may include two blade wings. The cutting path of each blade wing is defined by the leading edge of the blade wing. Each of the blade wings may be angled, twisted, or otherwise shaped so that the leading edges of the two blade wings are not the same. This means that the cutting path is not the same. Some other blades are upturned or angled from a center body relative a drive shaft. Examples of such blades are shown in U.S. Pat. Nos. 7,552,885 and 8,690,093, the entireties of which are incorporated by reference herein. The metal blades are designed with specific bends and geometries to create thrust (pull material past the blade) and shear (cutting and aerating action). The location, size and angle of each bend dictates the effect the bent portion will have during blending.

Disclosed herein is a blending system comprising a consumer lid or cup that is utilized during the blending process as a cover to a blender container and that is deliverable to a consumer. The blender system may include a base and a container, wherein the container may be selectively and operatively engagable with the base (and vice versa). The container may be sized and shaped to accommodate, as a cover of the container, an interior circumference or an edge circumference of a consumer lid, cup, bowl, mug or the like. A blender container attachment or adaptor may also be used to facilitate the interaction and fluid seal between the container and the consumer lid or cup. The consumer lid or cup may serve as the cover of the container during the blending of foodstuff and may contain the blended product within the container during the blending process. After blending, the consumer lid or cup, just used on the blender container, may be used as the lid or cup that is presented or given to the consumer and that houses the blended foodstuff for consumption by the consumer.

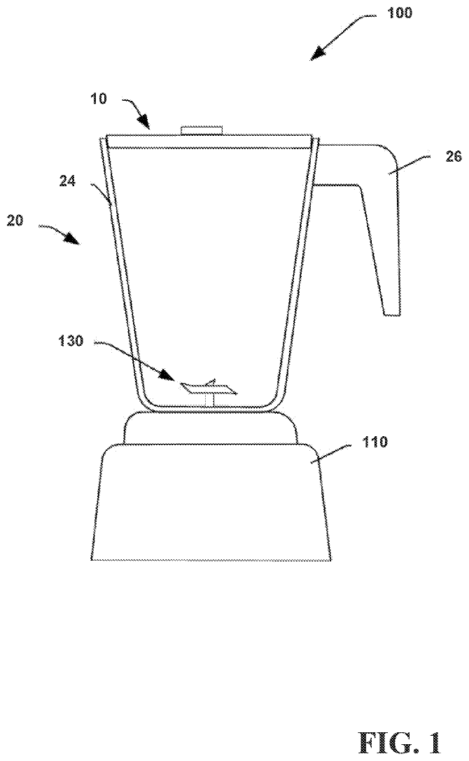

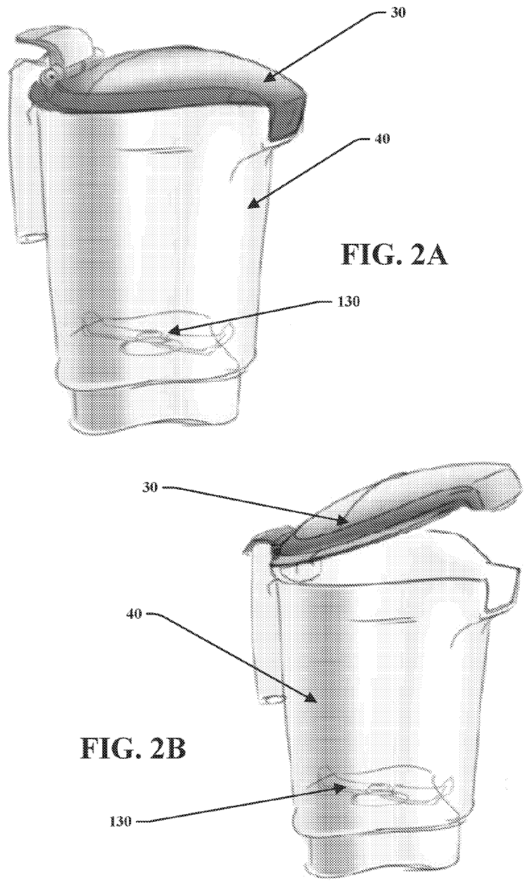

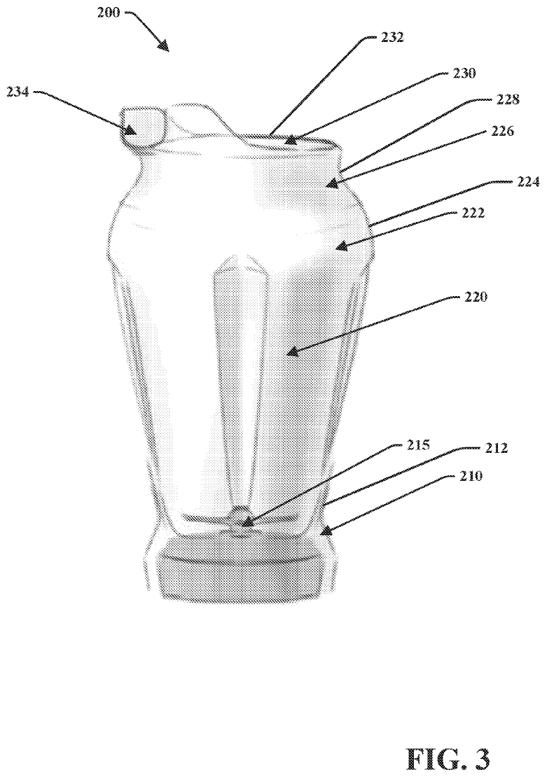

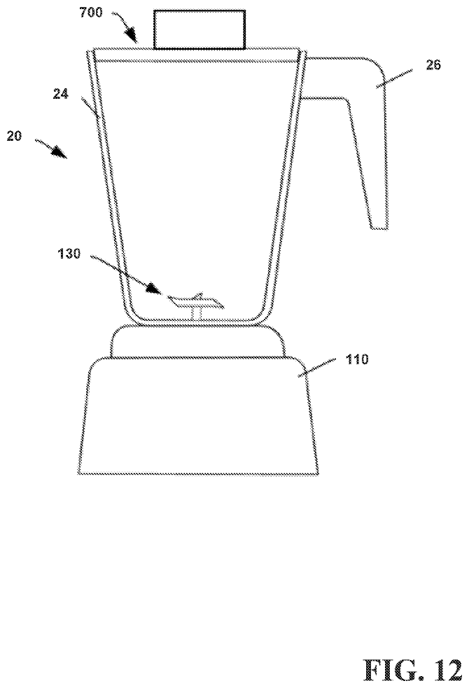

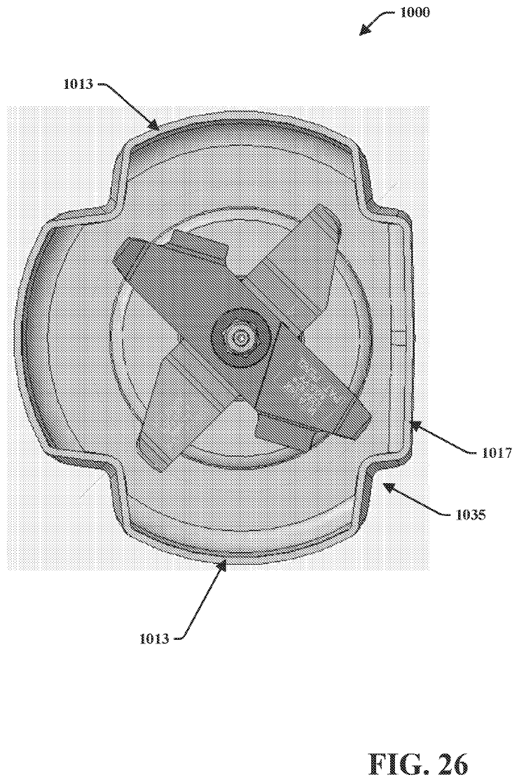

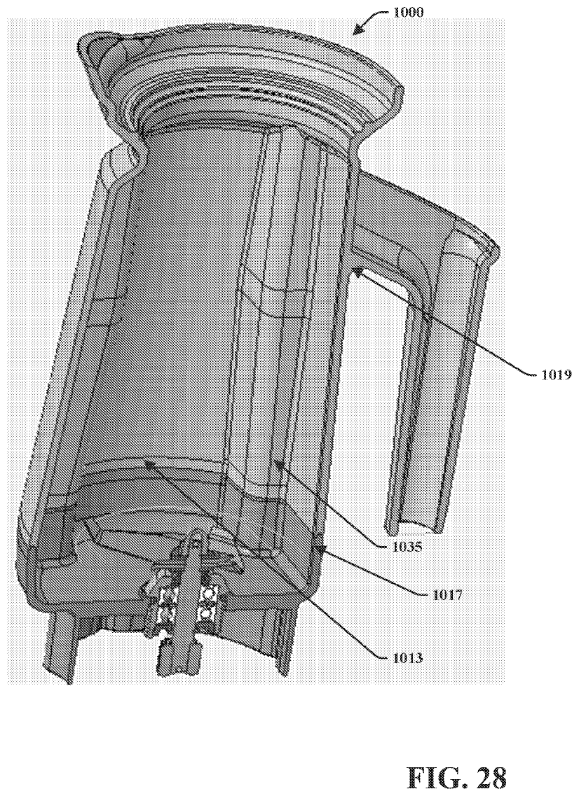

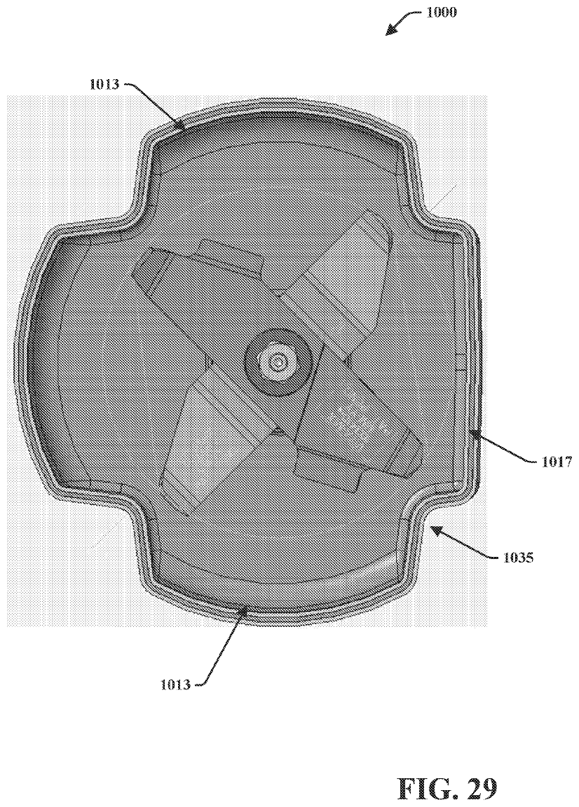

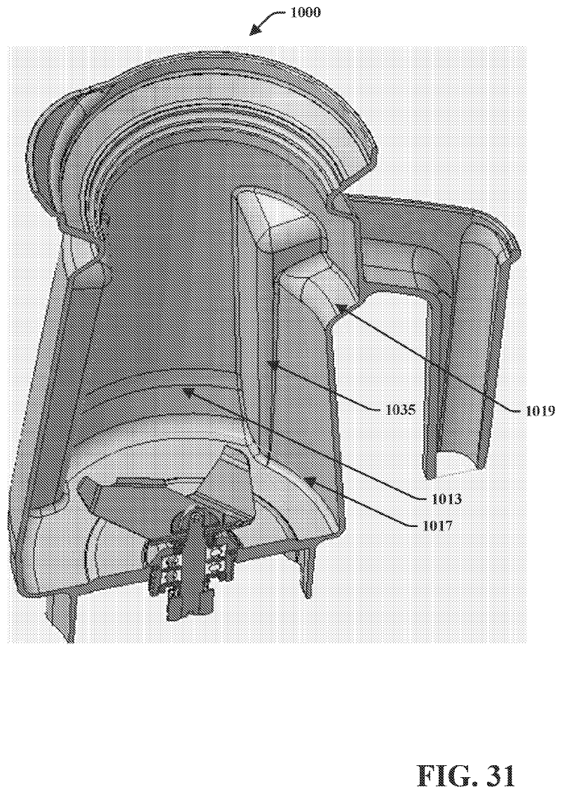

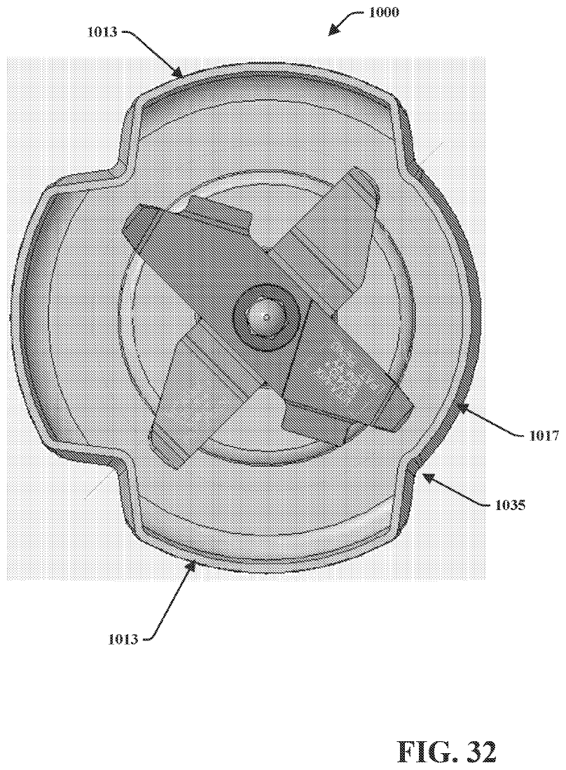

Referring now to FIG. 1, shown is a blending system 100 that comprises a container 20 and conventional cover 10. A container 40 and a hinged cover 30 may be used with system 100 as shown in FIG. 2. System 100 may utilize various aspects disclosed herein. For instance, system 100 may be used with the other disclosed containers, consumer lids or cups, and adapters as disclosed herein and described with reference to FIGS. 3-36.

System 100 primarily includes a blender base 110, a container, such as containers 20, 40 operatively attachable to the blender base 110, a blade assembly 130 (which may include a shield member), and a cover, such as covers 10, 30 that may be operatively attached to the container 20, 40. The container 20, 40 may include walls 24, 44 and a handle 26, 46. Foodstuff may be added to the container 20, 40 for blending. It is noted that the container 20, 40 may comprise various materials such as plastics, glass, metals, or the like, including, without limitation they may be formed from a Tritan copolyester material. In another aspect, container 20, 40 may be powered in any appropriate manner, such as disclosed in U.S. patent application Ser. No. 14/213,557, entitled Powered Blending Container, which is hereby incorporated by reference.

The blender base 110 may be any appropriate size and configuration. The base 110 may house and generally protect the operative components of the blending system 100, such as a motor and other components (e.g., fan, controllers, circuitry, and human interfaces). The base 110 may include a power source (e.g., battery) or may be in communication with a power source (e.g., power mains) that may power the motor and other components (e.g., a display, lighting, or the like). The motor may selectively drive the blade assembly 130 (e.g., cutting blades, chopping blades, whipping blades, spiralizing blades, etc.). The blade assembly 130 may agitate, impart heat, or otherwise interact with contents within the container 20, 40. The cover 10, 30 may cover an opening of the container and enclose the contents and blended contents therein during operation of the blended system.

The blade assembly 130, container 20, 40, base 110, and cover 10, 30 may removably or irremovably attach together. While shown as a large-format system, system 100 may comprise a single serving style container as described herein.

In at least one embodiment, the blending system 100 may identify or detect whether the system 100 is interlocked through a magnetic detection (e.g., reed switches) as described herein. A shield member may block interference with the reed switch by a magnetic field generated by the motor in accordance with various disclosed aspects.

System 100 and processes described herein generally relate to blending or food-processing systems and include a food-processing disc comprising one or more inductive coils. In another aspect, one or more of the disc and/or other component of the blending system may comprise an NFC component that may interact with an NFC component of a blender base. The NFC component of the blender base may receive information regarding the type of the disc and may utilize the blender base and may utilize the information to determine a blending process to be utilized by the system.

It is noted that the base 110, blade assembly 130, and other components of FIGS. 1-2 as described may similarly interact and operate with any of the containers described herein, including containers 200, 300, 400, 500, 800, 900, 1000, 1100 as described with reference to containers 20, 40. For example, the blade assembly 130 may agitate, impart heat, or otherwise interact with contents within any of the containers described herein, including containers 200, 300, 400, 500, 800, 900, 1000, 1100. The blade assembly 130, containers 200, 300, 400, 500, 800, 900, 1000, 1100, base 110, and cover 10, 30 may removably or irremovably attach. The containers 200, 300, 400, 500, 800, 900, 1000, 1100 may include walls and may includes embodiments with a handle or without a handle. Foodstuff may be added to the containers 200, 300, 400, 500, 800, 900, 1000, 1100 for blending. It is noted that any of the containers described herein, including containers 200, 300, 400, 500, 800, 900, 1000, 1100, may comprise various materials such as plastics, glass, metals, or the like.

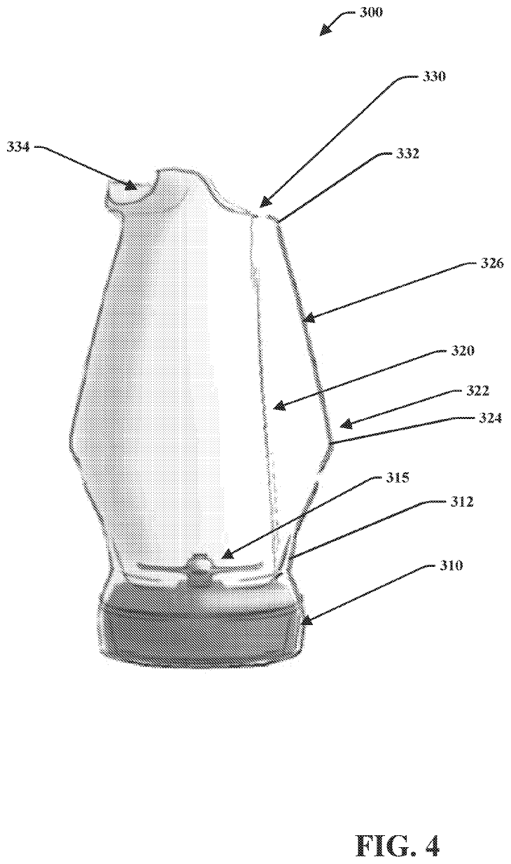

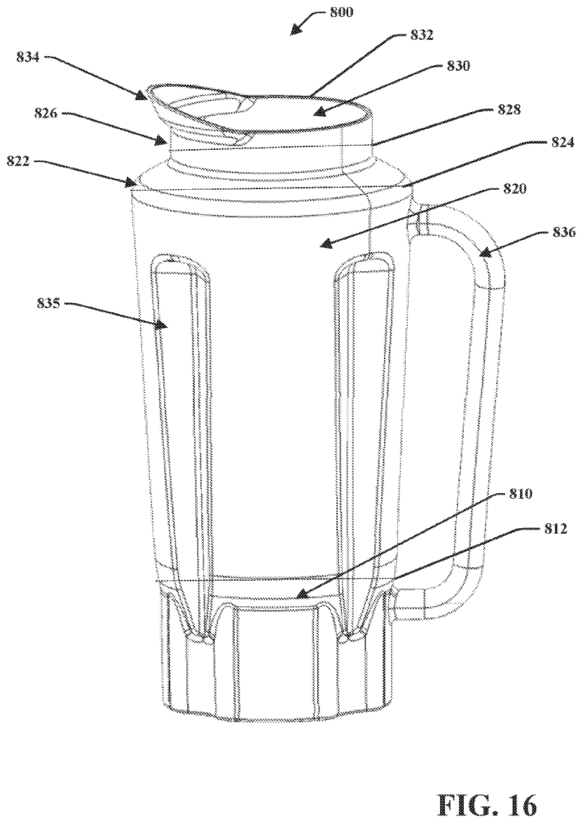

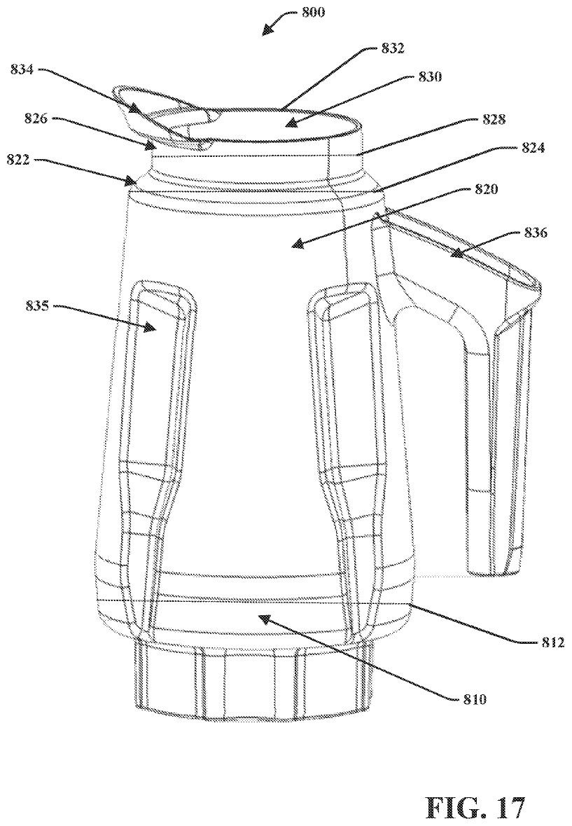

Turning now to FIGS. 3-5, 14 and 16-36, shown are various embodiments of containers 200, 300, 400, 500, 800, 900, 1000, 1100. It is noted that the term “container” as used herein may refer to any of containers 200, 300, 400, 500, 800, 900, 1000, 1100, etc., and that aspects of each of the described embodiments of containers may be combined without departing from this disclosure. For example, the open end and mating aspects of container 800 shown in FIG. 16 may be combined with the body shape of container 900 shown in FIG. 17, the body shape of container 300 shown in FIG. 4, or any of the other embodiments described.

The containers 200, 300, 400, 500, 800, 900, 1000, 1100 may include and/or be coupled with a blade assembly 130. As described herein, the containers 200, 300, 400, 500, 800, 900, 1000, 1100 may comprise appropriate configurations to allow for holding, mixing, and pouring foodstuff therein. It is noted that the containers 200, 300, 400, 500, 800, 900, 1000, 1100 may comprise materials such as metals, plastics, glass, or other food grade materials, including, without limitation being Tritan copolyester material. In an embodiment, the containers 200, 300, 400, 500, 800, 900, 1000, 1100 may be blow-molded or injection-molded. In an embodiment, the containers 200, 300, 400, 500, 800, 900, 1000, 1100 may comprise blow-molded Tritan copolyester. Containers 200, 300, 400, 500, 800, 900, 1000, 1100 may be configured according to a desired embodiment.

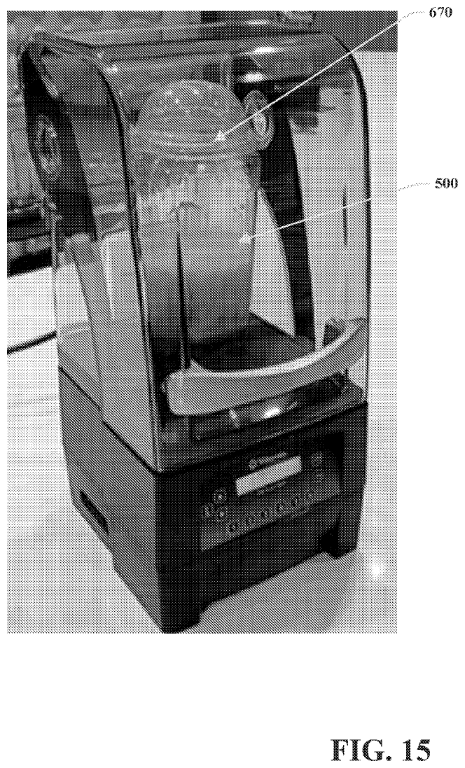

It is noted that the various aspects disclosed herein, however, may be applicable to other forms of containers, including, for example, containers 20, 40 shown in FIGS. 1-2 or containers not shown but that are known in the art, including, for example, single serving containers, food processing containers, etc. The container 200, 300, 400, 500, 800, 900, 1000, 1100 may operatively couple with a blender base, such as the blender base 110 shown in FIGS. 1-2 or the blender enclosure shown in FIG. 15 or may be adapted to couple with any blender base 110, blade assembly 130, or enclosure as may be known in the art.

FIG. 3 shows an embodiment of a container 200. Container 200 may comprise an open body 220, having one or more (or a plurality of) sidewalls, configured to receive and hold foodstuff. The body may include a blade assembly 215 (or 130, for example) at its base or closed end 210. The blade assembly 215 and base 210 of the container 200 may be configured to operatively couple to a blender base, such as blender base 110 shown in FIG. 1 or blender enclosure shown in FIG. 15. The body 220 of the container 200 may taper from the base 210, having a first diameter or circumference 212, to a widest point 222 having a second diameter or circumference 224. The body 210 of the container 200 may taper again from the widest point 222, 224 to a more narrow point at a neck 226 of the container 200, having a third diameter or circumference 228. The neck 226 may include an opening 230, configured to receive foodstuff. The opening 230 may have a diameter or perimeter circumference or edge 232 that is approximately the same as, wider than, or narrower than the circumference 228 of the neck 226 from which the opening 230 extends. In an embodiment, as shown in FIG. 3, the diameter or perimeter circumference 232 of the opening 230 may be wider than the narrower diameter or circumference 228 of the neck 226. The opening 230 may also include a spout 234 that is configured to enable pouring of the blended contents therein or the opening 230 may not include a spout and may enable pouring without a spout.

Generally, the container 200 may be sized and shaped to blend a desired quantity of foodstuff and to receive a consumer cup or lid in lieu of a cover 10, 30 (as described in respect to FIGS. 3-36). The opening 230 of the container 200 may generally correspond to the consumer cup or lid. For example, the circumference 232 of the opening 230 may generally correspond to a circumference of the cup or lid so that the cup or lid may engage with or operatively attach to the opening 230 of the container 200. In another example, the circumference 232 of the opening 230 may be smaller or more narrow than a circumference of the cup or lid so that the cup or lid may be placed or fit over to the opening 230 of the container 200. Alternatively, the circumference 232 of the opening 230 may be larger or greater than a circumference of the cup or lid so that the cup or lid may be placed snugly within or into to the opening 230 of the container 200.

Notably, the container 200, and circumference 232 of the opening 230 thereof, may be able to accommodate each of the above described fittings (engagement with corresponding diameter, loose fitting over the container 200, snug fitting within the container 200, etc.) with difference sized and shaped consumer cups or lids. Other diameters of the container 200 may also be provided to accommodate different sized cups or lids, or other containers, such as bowls, etc.

FIG. 4 shows an embodiment of a container 300. Container 300 may comprise an open body 320 configured to receive and hold foodstuff. The body may include a blade assembly 315 (or 130, for example) at its base 310. The blade assembly 315 and base 310 of the container 300 may be configured to operatively couple to a blender base, such as blender base 110 shown in FIG. 1 or blender enclosure shown in FIG. 15. The body 320 of the container 300 may taper from the base 310, having a first diameter or circumference 312, to a widest point 322 having a second diameter or circumference 324. The body 310 of the container 300 may taper again from the widest point 322, 324 to a more narrow point at a neck 326 or opening 330 of the container 300. The neck 326 may include opening 330, configured to receive foodstuff. The opening 330 may have a diameter or perimeter circumference 332 that is approximately the same as, wider than, or narrower than the neck 326 from which the opening 330 extends. In an embodiment, as shown in FIG. 4, the diameter or perimeter circumference 332 of the opening 330 may be narrower than the diameter or circumference of the neck 326, since the neck 326 may taper completely into or continuously until the opening 330. The opening 330 may also include a spout 334 that is configured to enable pouring of the blended contents therein or the opening 330 may not include a spout and may enable pouring without a spout.

Generally, the container 300 may be sized and shaped to blend a desired quantity of foodstuff and to receive a consumer cup or lid in lieu of a cover 10, 30 (as described in respect to FIGS. 3-36). The opening 330 of the container 300 may generally correspond to the consumer cup or lid. For example, the circumference 332 of the opening 330 may generally correspond to a circumference of the cup or lid so that the cup or lid may engage with or operatively attach to the opening 330 of the container 300. In another example, the circumference 332 of the opening 330 may be smaller or narrower than a circumference of the cup or lid so that the cup or lid may be placed or fit over to the opening 330 of the container 300. Alternatively, the circumference 332 of the opening 330 may be larger or greater than a circumference of the cup or lid so that the cup or lid may be placed snugly within or into to the opening 330 of the container 300.

Notably, the container 300, and circumference 332 of the opening 330 thereof, may be able to accommodate each of the above described fittings (engagement with corresponding diameter, loose fitting over the container 300, snug fitting within the container 300, etc.) with difference sized and shaped consumer cups or lids. Other diameters of the container 300 may also be provided to accommodate different sized cups or lids, or other containers, such as bowls, etc. The diameters described in respect to container 300 may be similar or different from those described in respect to container 200. Notably, as FIGS. 3-4 show, the widest point 224, 324 may occur at any point along the body 210, 310 of the container 200, 300, including closer to the base 210, 310 (shown in FIG. 4) or close to the opening 230, 330 (shown in FIG. 3).

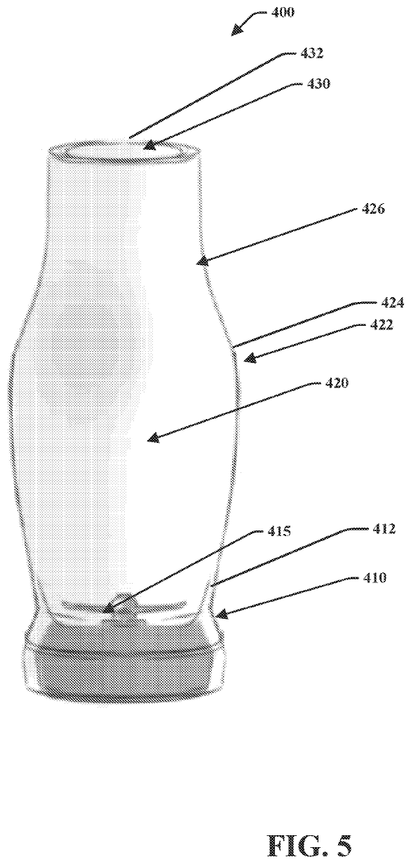

FIG. 5 shows an embodiment of a container 400. Container 400 may comprise an open body 420 configured to receive and hold foodstuff. The body 420 may include a blade assembly 415 (or 130, for example) at its base 410. The blade assembly 415 and base 410 of the container 400 may be configured to operatively couple to a blender base, such as blender base 110 shown in FIG. 1 or blender enclosure shown in FIG. 15. The body 410 of the container 400 may taper from the base 410, having a first diameter or circumference 412, to a widest point 422 having a second diameter or circumference 424. The body 420 of the container 400 may taper again from the widest point 422, 424 to a more narrow point at a neck 426 or opening 430 of the container 400. The neck 426 may include opening 430, configured to receive foodstuff. The opening 430 may have a diameter or perimeter circumference 432 that is approximately the same as, wider than, or narrower than the neck 426 from which the opening 430 extends. In an embodiment, as shown in FIG. 5, the diameter or perimeter circumference 432 of the opening 430 may be approximately the same as the diameter or circumference of the neck 426, since the neck 426 may taper initially from the widest point 422, 424 and then level out or be more straight for a certain length until the opening 430. The opening 430 may also include a spout that is configured to enable pouring of the blended contents therein or the opening 430 may not include a spout and may enable pouring without a spout. In an embodiment, the neck 426 and opening 430 may be able to extend well into or almost entirely into a cup so that the container 400 may remain in the cup as it is inverted to facilitate pouring of the food contents therein.

Generally, the container 400 may be sized and shaped to blend a desired quantity of foodstuff and to receive a consumer cup or lid in lieu of a cover 10, 30 (as described in respect to FIGS. 3-36). The opening 430 of the container 400 may generally correspond to the consumer cup or lid. For example, the circumference 432 of the opening 430 may generally correspond to a circumference of the cup or lid so that the cup or lid may engage with or operatively attach to the opening 430 of the container 400. In another example, the circumference 432 of the opening 430 may be smaller or narrower than a circumference of the cup or lid so that the cup or lid may be placed or fit over to the opening 430 of the container 400. Alternatively, the circumference 432 of the opening 430 may be larger or greater than a circumference of the cup or lid so that the cup or lid may be placed snugly within or into to the opening 430 of the container 400.

Notably, the container 400, and circumference 432 of the opening 430 thereof, may be able to accommodate each of the above described fittings (engagement with corresponding diameter, loose fitting over the container 400, snug fitting within the container 400, etc.) with difference sized and shaped consumer cups or lids. Other diameters of the container 400 may also be provided to accommodate different sized cups or lids, or other containers, such as bowls, etc. The diameters described in respect to container 400 may be similar or different from those described in respect to containers 200, 300. Notably, as FIGS. 3-5 show, the widest point 224, 324, 424 may occur at any point along the body 210, 310, 410, of the container 200, 300, 400 including closer to the base 210, 310, 410 (shown in FIG. 4) or close to the opening 230, 330, 430 (shown in FIG. 3), or generally or near the middle of the body (shown in FIG. 5). FIGS. 3-5 also show variations in tapering (more angled in FIG. 4, less angled in FIG. 5).

It is noted that the particular shape of the container 400, including the described tapering and elongated, but relatively straight neck, may allow for easy grasping or grabbing of the container 400 by a user.

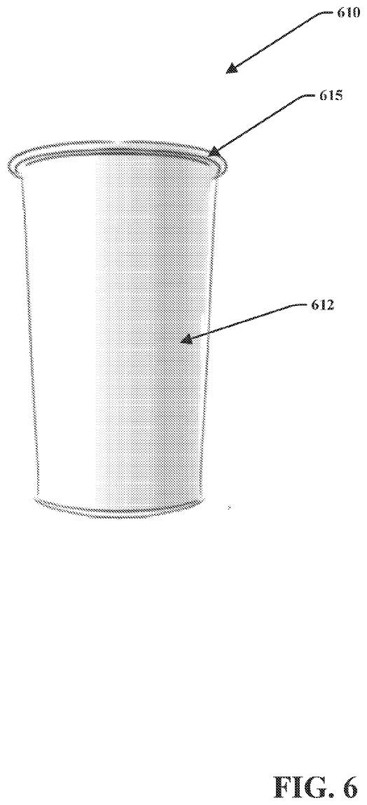

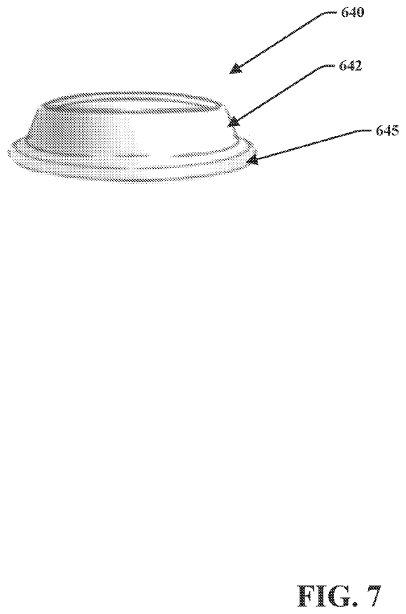

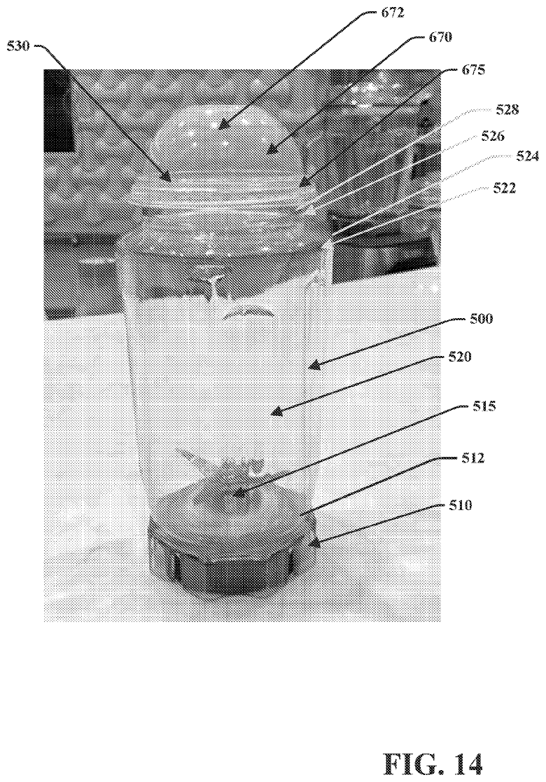

Turning to FIGS. 6-7, shown are a consumer or serving cup 610 and a consumer or serving lid 640. FIG. 14 also shows another variation of container 500 and lid 670 described herein. Consumer cup 610 may generally include an elongated body portion 612 and an opening or lip 615. Consumer lid 640 may generally include a short body portion 642 and an opening or lip 645. The diameter or circumference of each the consumer cup 610 and consumer lid 640 may be approximately the same. In an embodiment, the diameter or circumference of each the consumer cup 610 may be slightly smaller than the consumer lid 640. In an embodiment, opening or lip 615 of the consumer cup 610 may selectively engage with the opening or lip 645 of the consumer lid 640, where the opening or lip 645 of the consumer lid 640 may snap fit or friction fit over the opening or lip 615 of the consumer cup 610. The opening or lip 615 of the consumer cup 610 and the opening or lip 645 of the consumer lid 640, and each diameter or circumference thereof, may generally correspond with the diameter or circumference 232, 332, 432 of each opening 230, 330, 430 of the containers 200, 300, 400 (and corresponding aspects of containers 500, 800, 900, 1000, 1100). In an embodiment, the diameter or circumference of the consumer cup 610 and consumer lid 640 may be slightly larger than the diameter or circumference 232, 332, 432 of each opening 230, 330, 430 of the containers 200, 300, 400 so that the consumer cup 610 and consumer lid 640 may fit over the openings 230, 330, 430 of the containers 200, 300, 400 (and corresponding aspects of containers 500, 800, 900, 1000, 1100).

The coupling of the consumer cup 610 and consumer lid 640 over the openings 230, 330, 430 of the containers 200, 300, 400 may be loose fitting, snap fitting, friction fitting, air tight or liquid tight, or the like. The container 200, 300, 400 or the consumer cup 610 and consumer lid 640 may include latches, threads, different sized indents around the lip or opening of the container 200, 300, 400 sized for different sized consumer cups 610 and consumer lids 640 (similar to stadium seating or steps). The container 200, 300 400 can be latched, clipped, threaded, vacuum sealed, friction fit or otherwise held onto the consumer cups 610 and consumer lids 640 or vice versa. The foregoing is similarly applicable for containers 500, 800, 900, 1000, 1100.

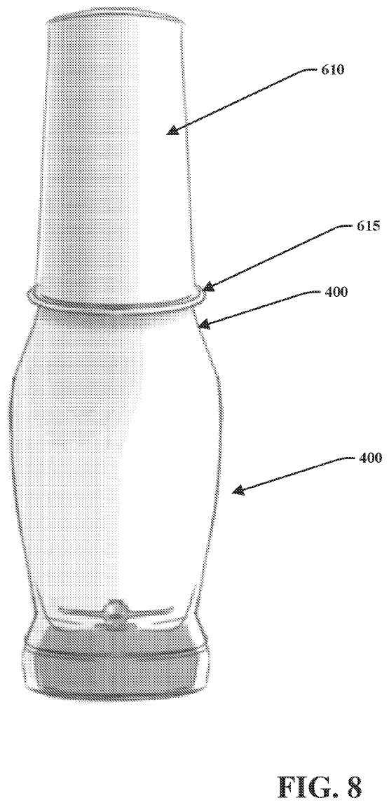

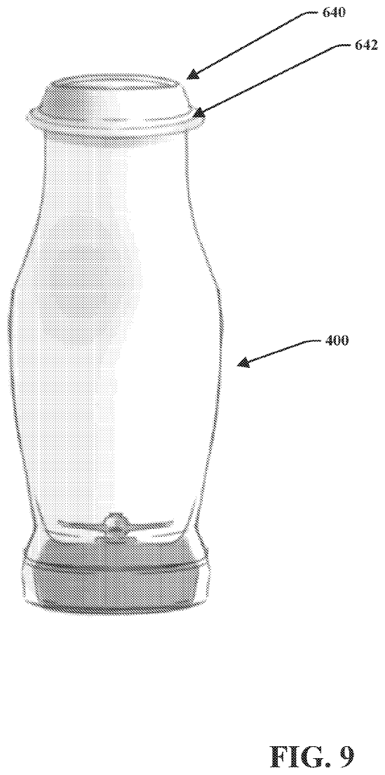

Consumable syrups can be used to hold consumer cup 610 and consumer lid 640 in place. FIG. 8, for example, shows coupling of the container 400 with consumer cup 610. FIG. 9, for example, shows coupling of the container 400 with consumer lid 640. As shown, the consumer cup 610 may be positioned and extend over the neck 426 of the container 400 which the consumer lid 640 may be positioned and extend over the opening 430 and a smaller portion of the neck 426 of the container 400. In an embodiment, the opening or lip 612 of the consumer cup 610 may rest on a wider portion 422 or 426 of the container or the interior of the base of the consumer cup 610 may rest on the opening 430 of the container 400. The container 400 may also include arms that extend from the container 400 and that couple with the consumer cup 610 or lid 640. The opening or lip 642 of the consumer lid 640 may engage with or rest on the opening 430 or neck 426 of the container 400.

The consumer cup 610 and consumer lid 640 or the openings 230, 330, 430 of the containers 200, 300, 400 (and corresponding aspects of containers 500, 800, 900, 1000, 1100) may also include engagement features such as small intentions or protrusions, threading, mating recesses and projections, or the like. An enclosure, such as the blending enclosure shown in FIG. 15 may be used to facilitate blending of the foodstuff within the containers. In an embodiment, the blending container is configured to insert into the enclosure and carry out a blending operation without the serving cup lid or the inverted serving cup. A sound enclosure may also be used. The sound enclosure may include soft foam material or other material that presses the consumer cup 610 and consumer lid 640 without damaging the consumer cup 610 and consumer lid 640. The sound enclosure may be positioned on either the container 200, 300, 400 or the consumer cup 610 and consumer lid 640 itself (and corresponding aspects of containers 500, 800, 900, 1000, 1100). The sound enclosure can automatically feed the consumer cup 610 and consumer lid 640 onto the blending container 200, 300, 400 (and containers 500, 800, 900, 1000, 1100) through a shoot, similar to how cups may be stacked and pulled out at fast food restaurants Notably, as described herein, these consumer cup 610 and consumer lid 640 may both serve as the cover of the blending container 200, 300, 400 (and containers 500, 800, 900, 1000, 1100) during blending and may be coupled to another corresponding consumer cup 610 and consumer lid 640 to be served to the customer.

The consumer cup 610 and consumer lid 640 may be disposable or single use. In an embodiment, the consumer cup 610 and consumer lid 64 may be reusable. The consumer cup 610 and consumer lid 640 may also not be served to a customer and can be single use within the commercial setting or the like. The consumer cup 610 and consumer lid 640, and corresponding containers 200, 300, 400 may be used in commercial settings. The consumer cup 610 and consumer lid 640 may take the form of customer lids or cups that will contain the blended product during blending and when served to the customer. For example, the consumer cup 610 and consumer lid 640 for a frozen smoothie or coffee drink can be placed on a blender container (such as container 200, 300, 400) after ingredients are added. The consumer cup 610 and consumer lid 640 may stay on the container (such as container 200, 300, 400) during blending. When blending is finished the consumer cup 610 and consumer lid 640 may be used on the customer's cup and served to the customer. In reference to the consumer lid 640, the lid 640 may be placed or positioned on the container (such as container 200, 300, 400) as if the container where a serving cup or as if lid 640 was a blender cover. In reference to the consumer cup 610, the cup may be inverted and placed or positioned over the opening of the container (such as container 200, 300, 400). Once blended, the contents can be placed in the consumer cup 610 that was just used as a cover during blending. The container 200, 300, 400 and cup 610 may be inverted, and the cup 610 may remain over and coupled to the opening or neck of the container, and the contents may flow directly into the cup 610. In this embodiment, a new and unused customer's lid can then be attached to the cup 610. In this version, the customer's lid does not get splashed so an end product may have improved appearance. The foregoing is similarly applicable for containers 500, 800, 900, 1000, 1100.

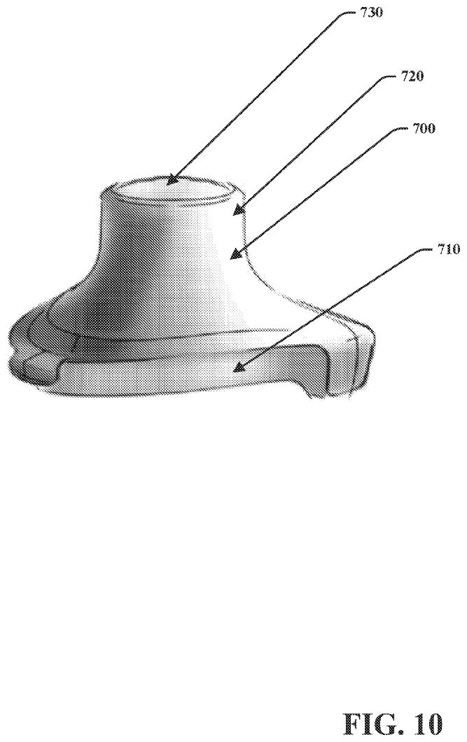

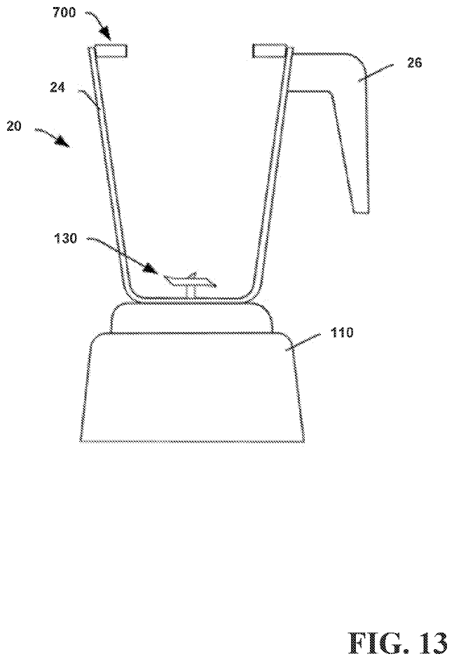

FIGS. 10-13 show an adapter 700. It is noted that the adaptor 700 may be provided separate but attachable to a container or the adaptor 700 may be provided as a part of or integral to the container (such as those containers described herein). The adapter 700 may include a base 710 and an opening 730. In an embodiment, the adaptor 700 may further include a neck 720 as shown in FIGS. 10-12, for example. The neck 720 and opening 730 may be substantially similar to the neck 426 and opening 430 of container 400 shown in FIG. 5 or the other necks and openings of any of the containers disclosed and described herein. The neck 720 and opening 730 may have substantially the same diameter. In an embodiment, the adaptor 700 may not include a neck and the opening 730 may be in line with the base 710 as shown in FIG. 13, for example. The adaptor 700 may facilitate coupling with a consumer cup 610 or lid 640 such that the consumer cup 610 or lid 640 may operatively cover the opening 730 of the adaptor 700. The base 710 of the adapter may have a larger diameter or circumference than the diameter or circumference of the opening 730. The base 710 of the adaptor 700 may be sized and shaped to couple to a container, such as containers 20, 40 or to any of the containers disclosed and described herein.

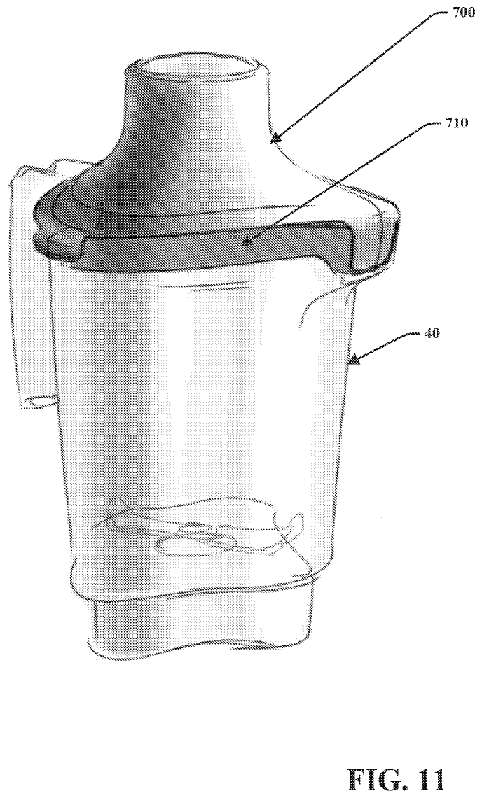

FIGS. 11-13 shows coupling of the adapter 700 to containers 20, 40, for example. The adapter 700 may matingly engage with the container such that it creates a liquid tight seal with the container. The adaptor 700 may attach to or couple with an outer diameter of the container or the adaptor may attach to or couple with an inner diameter of the container. The adaptor 700 may attach to or couple with a perimeter edge of the container. For example, the attachment may be loose fitting, snap fitting, friction fitting, air tight or liquid tight, or the like. The adapter 700 may include latches, threads, different sized indents around the base 710 of the adapter 700 to engage with a container, it may friction fit with a container or it may operatively attach with a container in any appropriate manner. It is noted that the engagement features, and other aspects, as described for the bodies, necks, and openings of containers 200, 300, 400 (and containers 500, 800, 900, 1000, 1100) may also be applied to the neck 720 and opening 730 of the adapter but are not repeated for the sake of brevity.

The adapter 700 may attach to the container by a hinge fitting so that the unhinged portion of the adapter 700 may be lifted and the contents of the container may be poured out from the container, through a spout, for example, without having to remove the adapter 700. It is noted that the contents of the container may also be poured through the opening 730 of the adapter, similar to container 200, 300, 400 (and containers 500, 800, 900, 1000, 1100). In an embodiment, food contents may be inserted through the opening 730 to be blended and the blended contents may also be poured through the same opening 730 after blending. In an embodiment, the adapter 730 may not need to be moved or removed before or after using the blending system.

As described, adapter 700 may enable the retrofitting of a container (such as container 20, 40) having a larger opening that is configured to receive a larger blender cover (such as cover 10, 30). The adapter 700 may be designed to stay on for periods of time, allowing for rinsing while the adapter 700 stays on during rinsing with a Rinse-O-Matic. U.S. Pat. Nos. U.S. Pat. No. 7,104,474B2, U.S. Pat. No. 9,505,013B2 are hereby incorporated by reference. Every few hours (e.g., 4-5 hours), the adapter 700 can be removed for sanitation. The adapter 700 may also be useful in folding material (raw and blended material) back into blend. The adapter 700 can include a neck or beaker on the adapter 700 on which a consumer cup 610 or lid 640 may sit, similar to container 200, 300, 400 (and containers 500, 800, 900, 1000, 1100).

Turning to FIG. 14, shown is an additional embodiment of a container 500 and lid 670. Container 500 and lid 670 may include any of the features as described herein for containers 200, 300, 400 (and containers 500, 800, 900, 1000, 1100) and consumer cups 610 and lids 640. Container 500 may comprise an open body 520 configured to receive and hold foodstuff. The body may include a blade assembly 515 (or 130, for example) at its base 510. The blade assembly 515 and base 510 of the container 500 may be configured to operatively couple to a blender base, such as blender base 110 shown in FIG. 1 or blender enclosure shown in FIG. 15. The body 520 of the container 500 may be relatively straight or slightly taper from the base 510, having a first diameter or circumference 512, to a point 522 having a second diameter or circumference 524, that may be the same or just wider than the diameter or circumference 512 of the base. The body 510 of the container 500 may taper from point 522, 524 to a more narrow point at a neck 526 or opening 530 of the container 500. The neck 526 may include opening 530, configured to receive foodstuff. The opening 530 may have a diameter or perimeter circumference 532 that is approximately the same as, wider than, or narrower than the neck 526 from which the opening 530 extends. In an embodiment, as shown in FIG. 15, the diameter or perimeter circumference 532 of the opening 530 may be approximately the same as the diameter or circumference of the neck 526, but may be smaller than the diameters or circumferences 512 524 of the base 510 and point 522. In this embodiment, there may be two relatively straight portions of the container body 520 having different diameters or circumferences. The opening 530 may also include a spout that is configured to enable pouring of the blended contents therein or the opening 530 may not include a spout and may enable pouring without a spout. In an embodiment, the neck 526 and opening 530 may be able to extend well into or almost entirely into a cup so that the container 500 may remain in the cup as it is inverted to facilitate pouring of the food contents therein.

Generally, the container 500 may be sized and shaped to blend a desired quantity of foodstuff and to receive a consumer cup or lid in lieu of a cover 10, 30 (as described in respect to FIGS. 3-36). The opening 530 of the container 500 may generally correspond to the consumer cup or lid. For example, the circumference 532 of the opening 530 may generally correspond to a circumference of the cup or lid so that the cup or lid may engage with or operatively attach to the opening 530 of the container 500. In another example, the circumference 532 of the opening 530 may be smaller or narrower than a circumference of the cup or lid so that the cup or lid may be placed or fit over to the opening 530 of the container 500. Alternatively, the circumference 532 of the opening 530 may be larger or greater than a circumference of the cup or lid so that the cup or lid may be placed snugly within or into to the opening 530 of the container 500.

Notably, the container 500, and circumference 532 of the opening 530 thereof, may be able to accommodate each of the above described fittings (engagement with corresponding diameter, loose fitting over the container 500, snug fitting within the container 500, etc.) with difference sized and shaped consumer cups or lids. Other diameters of the container 500 may also be provided to accommodate different sized cups or lids, or other containers, such as bowls, etc. The diameters described in respect to container 500 may be similar or different from those described in respect to containers 200, 300, 400 (and containers 500, 800, 900, 1000, 1100).

FIG. 14 further shows a consumer lid 670. Consumer lid 670 may generally include a domed body portion 672 and an opening or lip 675. The diameter or circumference of each the consumer lid 670 may be approximately the same as consumer lid 640 and may include any of the features described herein for consumer cup 610 and consumer lid 640.

Regarding the consumer cup 610 and consumer lids 640, 670, in an embodiment, the cups and lids 610, 640, 670 may generally have a continuous surface. For example, when served to a consumer, and consumer may remove the lid 640, 670 to drink the contents therein. In another embodiment, the lids 640, 670 may include a drinking aperture or opening. In an embodiment, this drinking aperture or opening may be perforated or have a cross or x-shape so that it is relatively closed during the blending process are sufficiently closed to keep blended contents within the container and may be opened by the consumer so that the consumer can drink through the lid 640, 670.

Turning to FIGS. 16-36, shown are additional embodiments of containers 800, 900, 1000, 1100. The containers 800, 900, 1000, 1100 may include different shaped bodies and different mating aspects configured to operatively mate with or couple to a serving cup or serving lid 610, 640. The containers 800, 900, 1000, 1100 may include or incorporate any of the previously described aspects in relation to the blending system 100, containers 200, 300, 400, 500, adaptor 700, serving cups 610 and serving lids 640, etc., and in any combination, without departing from this disclosure. Similarly, any of the aspects hereafter described in relation to the containers 800, 900, 1000, 1100 may be included or incorporated into the previously described blending system 100, containers 200, 300, 400, 500, adaptor 700, serving cups 610 and serving lids 640, etc., and in any combination, without departing from this disclosure. It is further noted that any of the aspects hereafter described in relation to the containers 800, 900, 1000, 1100 may be combined with between each other and that any of the previously described aspects in relation to the blending system 100, containers 200, 300, 400, 500, adaptor 700, serving cups 610 and serving lids 640, etc. may be combined between each other, in an combination, without departing from this disclosure.

FIGS. 16-19 show embodiments of a container 800. Container 800 may comprise an open body 820 configured to receive and hold foodstuff. The body 820 may include a blade assembly (or 130, for example) at its base 810. The blade assembly and base 810 of the container 800 may be configured to operatively couple to a blender base, such as blender base 110 shown in FIG. 1 or blender enclosure shown in FIG. 15.

The body 820 of the container 800 may extend from the base 810, having a base diameter 812, to a shoulder 822 having a shoulder diameter 824. The shoulder 822 may taper inwardly and form a neck 826 having a neck diameter 828. The neck 826 may include an opening 830, wherein the opening 830 configured to receive foodstuff. The opening 830 may have a diameter 832 that is approximately the same as, wider than, or narrower than the diameter 828 of the neck 826. In an embodiment, the neck 826 or opening 830 may further include a lip 829. The lip 829 may be configured to operatively mate with the serving cup 610 or serving lid 640. The opening 830 may also include a spout 834 that is configured to enable pouring of the blended contents therein or the opening 830 may not include a spout and may enable pouring without a spout. The body 820 may further include one or more ribs 835 to facilitate, for example, mixing of foodstuff during a blending operation. The body 820 may further include a handle 836 to facilitate, for example, positioning of the container 800 and pouring of the blended contents, e.g., through tilting or inversion of the container 800.

As shown in FIG. 16, the base 810 and base diameter 812 may be smaller than the shoulder 822 and shoulder diameter 824. The circumference of the body 820 may gradually widen from the base 810 to the shoulder 822. The shoulder 822 may taper inwardly towards the neck 826, wherein the neck 826 and neck diameter 828 may be smaller than the shoulder 822 and shoulder diameter 824. The neck 826 and neck diameter 828 may be larger, smaller, or approximately the same as the base 810 and base diameter 812. In an embodiment, the neck 826 may form the opening 830 and there may be no separate lip, edge, or provision for a lid. The neck 826 may extend generally coaxially with the body 820. The spout 834 may extend from the perimeter edge 832 of the neck 826. The handle 836 may attach at two points to the body 820 of the container 800. In an example, the container 800 may comprise a standard draft body (e.g. 3 degree) and mixing ribs 835.

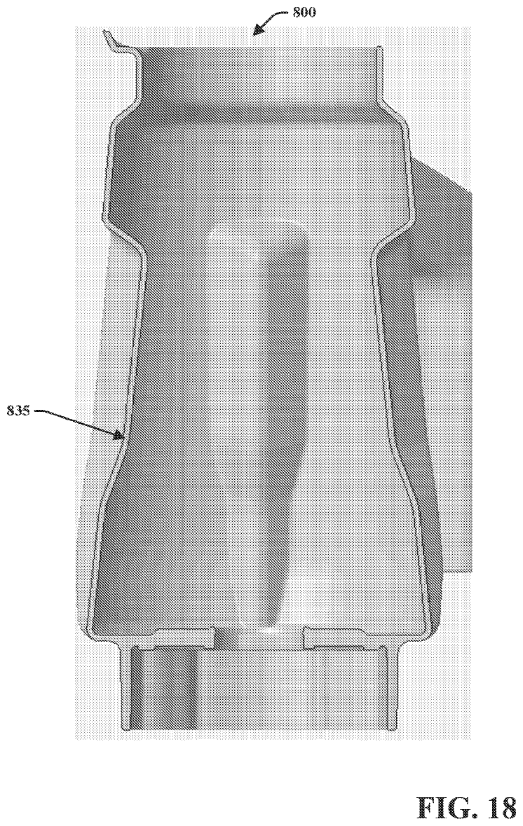

As shown in FIG. 17, the base 810 and base diameter 812 may be larger than the shoulder 822 and shoulder diameter 824. The circumference of the body 820 may gradually narrow from the base 810 to the shoulder 822. The shoulder 822 may taper inwardly towards the neck 826, wherein the neck 826 and neck diameter 828 may be smaller than the shoulder 822 and shoulder diameter 824. The neck 826 and neck diameter 828 may be smaller than the base 810 and base diameter 812. In an embodiment, the neck 826 may form the opening 830 and there may be no separate lip, edge, or provision for a lid. The neck 826 may extend generally coaxially with the body 820. The spout 834 may extend from the perimeter edge 832 of the neck 826. The handle 836 may attach at a single point to the body 820 of the container 800 and may be an ascent-type handle. In an example, the container 800 may comprise a reverse draft body (e.g. 5 degree) and reverse draft mixing ribs 835 (e.g. 6 degree). As shown in FIG. 18, the mixing ribs 835 may be stepped-in mixing ribs at the bottom of the body 820 towards the base 810.

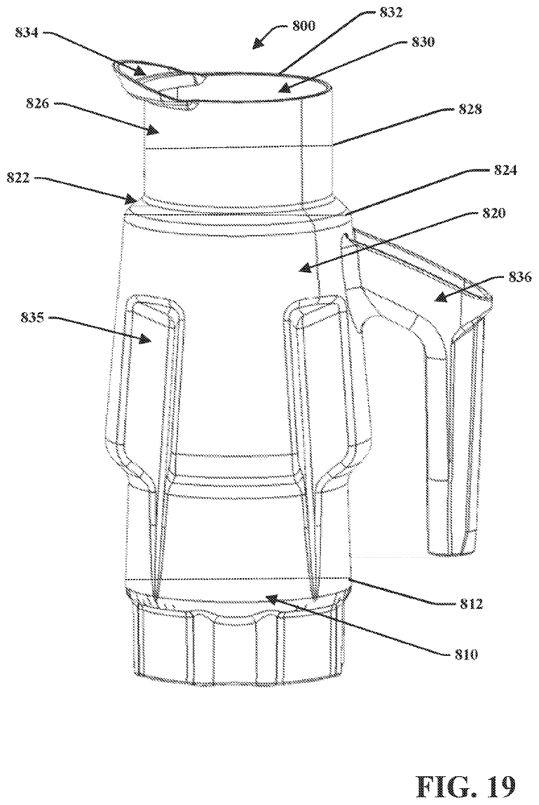

As shown in FIG. 19, the base 810 and base diameter 812 may be smaller than the shoulder 822 and shoulder diameter 824. The body 820 may include a first stepped-in portion having a smaller circumference than a second stepped-out portion having a larger circumference. In an embodiment, the stepped-in portion may be located at a lower portion of the body 820 towards the base 810 and the stepped-out portion may be located at an upper portion of the body 820 towards the opening 830. In an embodiment, the stepped-in portion may have a generally constant circumference and the stepped-out portion may gradually taper inwardly towards the shoulder 822. It is noted that the stepped-in portion may taper inward, outward, or remain generally constant and the stepped-out portion may taper inward, outward, or remain generally constant. In an example, the stepped-in portion may comprise approximately ¼ to ⅓ of the body 820 and the stepped-out portion may comprise approximately ½ to ⅔ of the body 820.

The shoulder 822 may taper inwardly towards the neck 826, wherein the neck 826 and neck diameter 828 may be smaller than the shoulder 822 and shoulder diameter 824. The neck 826 and neck diameter 828 may be larger, smaller, or approximately the same as the base 810 and base diameter 812. In an embodiment, the neck 826 may form the opening 830 and there may be no separate lip, edge, or provision for a lid. In an embodiment, the neck 826 may be elongated and may comprise approximately ¼ to ⅓ the container 800. The neck 826 may extend generally coaxially with the body 820. The spout 834 may extend from the perimeter edge 832 of the neck 826. The handle 836 may attach at a single point to the body 820 of the container 800 and may be an ascent-type handle. In an example, the container 800 may comprise a reverse draft body (e.g. 5 degree) and reverse draft mixing ribs 835 (e.g. 6 degree).

Although container 800 is described as having no separate lip, edge, or provision for a lid, it is noted that the container 800 in some embodiments may be used for blending without a consumer cup or lid 610, 640 and that the container 800 in some embodiments may be used for blending with a consumer cup or lid 610, 640. As described herein, the consumer cup or lid 610, 640 may couple with an interior surface of the neck 826 or perimeter edge 832, with an exterior surface of the neck 826 or perimeter edge 832, or directly with the perimeter edge 832. It is further noted that container 800 may be used with an enclosure, such as the enclosure shown in FIG. 15 or with an adaptor, such as adaptor 700.

Generally, the container 800 may be sized and shaped to blend a desired quantity of foodstuff and to receive a consumer cup or lid 610, 640 in lieu of a cover 10, 30 (as described in respect to FIGS. 3-36). The opening 830 of the container 800 may generally correspond to the consumer cup or lid. For example, the circumference 832 of the opening 830 may generally correspond to a circumference of the cup or lid so that the cup or lid may engage with or operatively attach to the opening 830 of the container 800. In another example, the circumference 832 of the opening 830 may be smaller or narrower than a circumference of the cup or lid so that the cup or lid may be placed or fit over to the opening 830 of the container 800. Alternatively, the circumference 832 of the opening 830 may be larger or greater than a circumference of the cup or lid so that the cup or lid may be placed snugly within or into to the opening 830 of the container 800.

Notably, the container 800, and circumference 832 of the opening 830 thereof, may be able to accommodate each of the above described fittings (engagement with corresponding diameter, loose fitting over the container 800, snug fitting within the container 800, etc.) with difference sized and shaped consumer cups or lids. Other diameters of the container 800 may also be provided to accommodate different sized cups or lids, or other containers, such as bowls, etc.

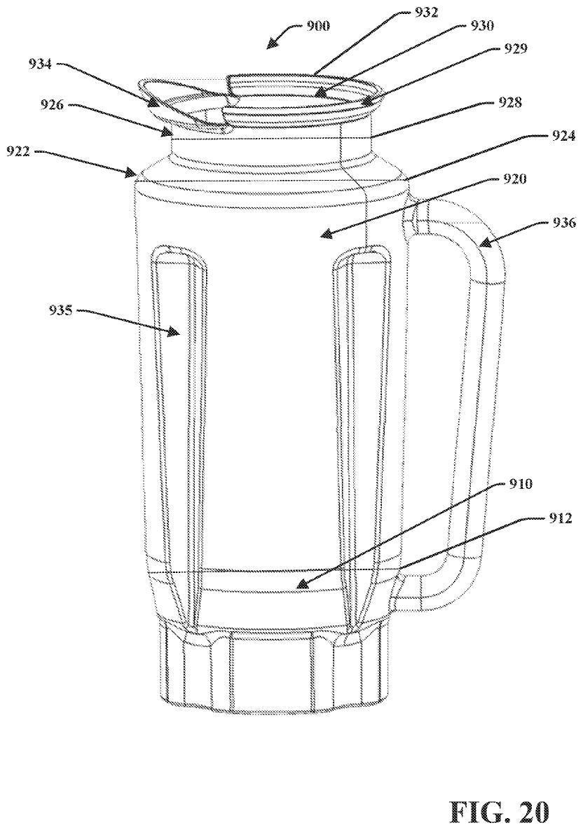

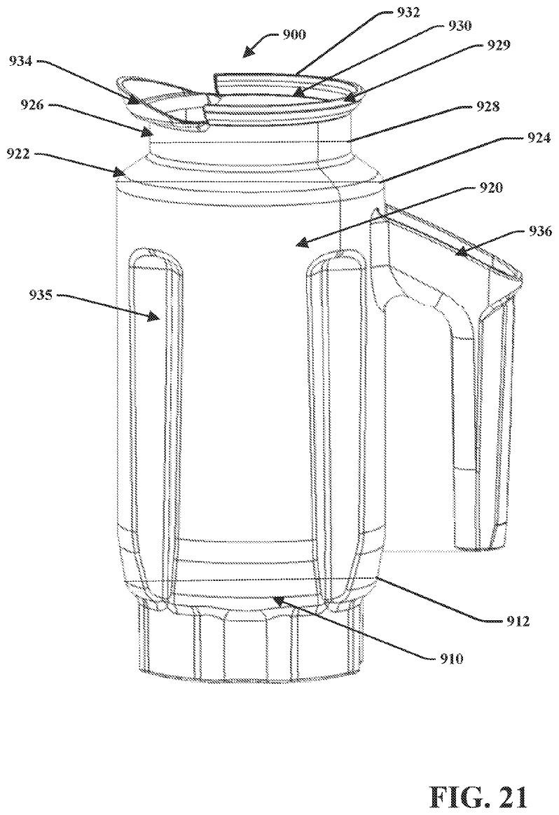

FIGS. 20-21 show embodiments of a container 900. Container 900 may comprise an open body 920 configured to receive and hold foodstuff. The body 920 may include a blade assembly (or 130, for example) at its base 910. The blade assembly and base 910 of the container 900 may be configured to operatively couple to a blender base, such as blender base 110 shown in FIG. 1 or blender enclosure shown in FIG. 15.

The body 920 of the container 900 may extend from the base 910, having a base diameter 912, to a shoulder 922 having a shoulder diameter 924. The shoulder 922 may taper inwardly and form a neck 926 having a neck diameter 928. The neck 926 may include an opening 930, wherein the opening 930 is configured to receive foodstuff. The opening 930 may have a diameter 932 that is approximately the same as, wider than, or narrower than the diameter 928 of the neck 926. In an embodiment, the neck 926 or opening 930 may further include a lip 929. The lip 929 may be configured to operatively mate with the serving cup 610 or serving lid 640. The opening 930 may also include a spout 934 that is configured to enable pouring of the blended contents therein or the opening 930 may not include a spout and may enable pouring without a spout. The body 920 may further include one or more ribs 935 to facilitate, for example, mixing of foodstuff during a blending operation. The body 920 may further include a handle 936 to facilitate, for example, positioning of the container 900 and pouring of the blended contents, e.g., through tilting or inversion of the container 900.

As shown in FIG. 20, the base 910 and base diameter 912 may be smaller than the shoulder 922 and shoulder diameter 924. The circumference of the body 920 may gradually widen from the base 910 to the shoulder 922. The shoulder 922 may taper inwardly towards the neck 926, wherein the neck 926 and neck diameter 928 may be smaller than the shoulder 922 and shoulder diameter 924. The neck 926 and neck diameter 928 may be larger, smaller, or approximately the same as the base 910 and base diameter 912. The neck 926 may extend generally coaxially with the body 920. In an embodiment, the neck 926 may form the opening 930. In an embodiment, the neck 926 or opening 930 may further include a lip 929. The spout 934 may extend from the neck 926. The handle 936 may attach at two points to the body 920 of the container 900. In an example, the container 900 may comprise a standard draft body (e.g. 1.5 degree) and reverse draft mixing ribs 935 (e.g. 0.5 degree).

As shown in FIG. 21, the base 910 and base diameter 912 may be approximately the same as the shoulder 922 and shoulder diameter 924. The circumference of the body 920 may remain generally straight from the base 910 to the shoulder 922. The shoulder 922 may taper inwardly towards the neck 926, wherein the neck 926 and neck diameter 928 may be smaller than the shoulder 922 and shoulder diameter 924. The neck 926 and neck diameter 928 may be smaller than the base 910 and base diameter 912. The neck 926 may extend generally coaxially with the body 920. In an embodiment, the neck 926 may form the opening 930. In an embodiment, the neck 926 or opening 930 may further include a lip 929. The spout 934 may extend from the neck 926. The handle 936 may attach at a single point to the body 920 of the container 900 and may be an ascent-type handle. In an example, the container 900 may comprise a no-draft body and reverse draft mixing ribs 935 (e.g. 1 degree).

In an embodiment, lip 929 may be configured to operatively mate with the serving lid or serving cup 610, 640 and may be configured to operatively receive a rim 615, 645 (e.g. an inner surface or an outer surface of rims 615, 645) of the serving lid 640 or serving cup 610 when the serving cup 610 is inverted. In an embodiment, lip 939 may be configured to operatively form a snap-fit or friction fit with the serving lid or serving cup 610, 640. In an embodiment, lip 939 may extend annularly from the opening 930 for a predetermined width. In an embodiment, lip 929 may further include a terminal end (e.g. perimeter edge 932 of the lip 929 of the opening 930) extending generally coaxially with the body 920.

In an embodiment, the lip 929 may extend from the neck 926 and the spout 934 may extend from the neck 926 so that the lip 929 and spout 934 occupy adjacent areas of the same vertical space above the neck 926. In an embodiment, the lip 929 may not extend around an entire circumference of the neck 926. In an embodiment, the lip 929 may extend around only a portion of the neck 926 (e.g. the portion of the neck 926 that does not include the spout 934). In an embodiment, the lip 929 may comprise a vertical terminal edge which may be generally perpendicular to the perimeter edge 932 of the lip 929. The vertical terminal edge may be near or adjacent to one or both sides of the spout 934.

Generally, the container 900 may be sized and shaped to blend a desired quantity of foodstuff and to receive a consumer cup or lid 610, 640 in lieu of a cover 10, 30 (as described in respect to FIGS. 3-36). The opening 930 of the container 900 may generally correspond to the consumer cup or lid. For example, the circumference 932 of the opening 930 may generally correspond to a circumference of the cup or lid so that the cup or lid may engage with or operatively attach to the opening 930 of the container 900. In another example, the circumference 932 of the opening 930 may be smaller or narrower than a circumference of the cup or lid so that the cup or lid may be placed or fit over to the opening 930 of the container 900. Alternatively, the circumference 932 of the opening 930 may be larger or greater than a circumference of the cup or lid so that the cup or lid may be placed snugly within or into to the opening 930 of the container 900.

Notably, the container 900, and circumference 932 of the opening 930 thereof, may be able to accommodate each of the above described fittings (engagement with corresponding diameter, loose fitting over the container 900, snug fitting within the container 900, etc.) with difference sized and shaped consumer cups or lids. Other diameters of the container 900 may also be provided to accommodate different sized cups or lids, or other containers, such as bowls, etc.

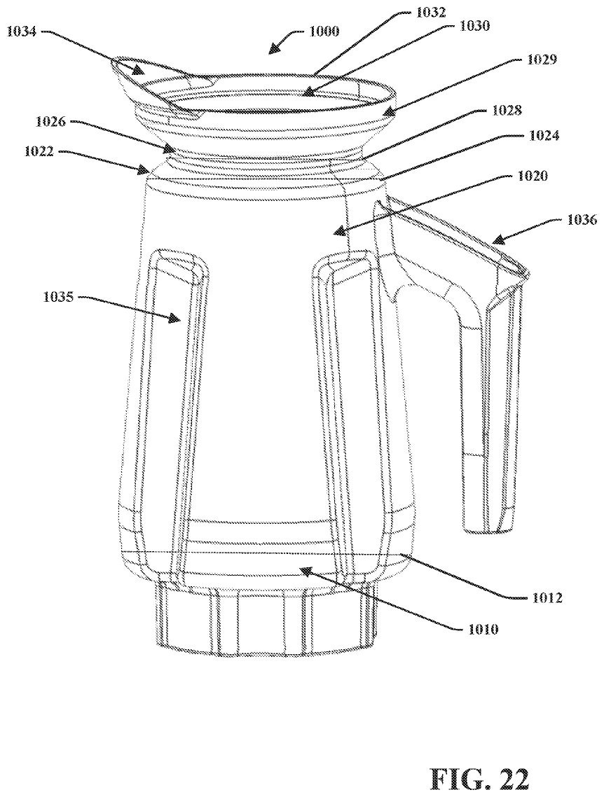

FIGS. 22-32 show embodiments of a container 1000. Container 1000 may comprise an open body 1020 configured to receive and hold foodstuff. The body 1020 may include a blade assembly 1015 (or 130, for example) at its base 1010. The blade assembly 1015 and base 1010 of the container 1000 may be configured to operatively couple to a blender base, such as blender base 110 shown in FIG. 1 or blender enclosure shown in FIG. 15.

The body 1020 of the container 1000 may extend from the base 1010, having a base diameter 1012, to a shoulder 1022 having a shoulder diameter 1024. The shoulder 1022 may taper inwardly and form a neck 1026 having a neck diameter 1028. The neck 1026 may include an opening 1030, wherein the opening 1030 configured to receive foodstuff. The opening 1030 may have a diameter 1032 that is approximately the same as, wider than, or narrower than the diameter 1028 of the neck 1026. In an embodiment, the neck 1026 or opening 1030 may further include a lip 1029. The lip 1029 may be configured to operatively mate with the serving cup 610 or serving lid 640. The opening 1030 may also include a spout 1034 that is configured to enable pouring of the blended contents therein or the opening 1030 may not include a spout and may enable pouring without a spout. The body 1020 may further include one or more ribs 1035 to facilitate, for example, mixing of foodstuff during a blending operation. The body may further include a handle 1036 to facilitate, for example, positioning of the container 1000 and pouring of the blended contents, e.g., through tilting or inversion of the container 1000.

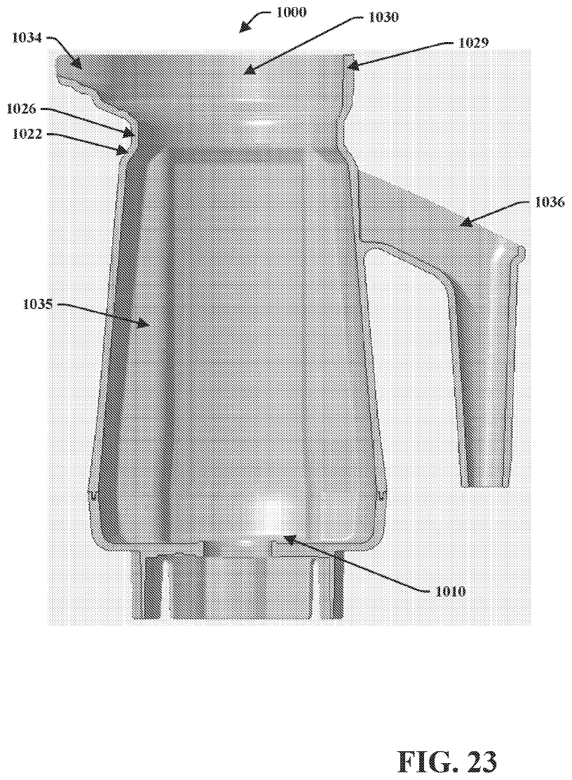

As shown in FIG. 22, the base 1010 and base diameter 1012 may be larger than the shoulder 1022 and shoulder diameter 1024. The circumference of the body 1020 may gradually narrow from the base 1010 to the shoulder 1022. The shoulder 1022 may taper inwardly towards the neck 1026, wherein the neck 1026 and neck diameter 1028 may be smaller than the shoulder 1022 and shoulder diameter 1024. The neck 1026 and neck diameter 1028 may be smaller than the base 1010 and base diameter 1012. The neck 1026 may extend generally coaxially with the body 1020. In an embodiment, the neck 1026 may further include a lip 1029. In an embodiment, the lip 1029 may form the opening 1030. The lip 1029 and opening 1030 may have a diameter larger, smaller, or approximately the same as any of the base 1010, shoulder 1022, or neck 1026. The lip 1029 may taper or flare outwards from the neck 1026. Between the neck 1026 and the lip 1029 may be a second shoulder having an inverse or mirrored shape compared to the first shoulder 1022. The spout 1034 may extend from the perimeter edge 1032 of the lip 1029. The handle 1036 may attach at a single point to the body 1020 of the container 1000 and may be an ascent-type handle. In an example, the container 1000 may comprise a reverse draft body (e.g. 5 degree) and reverse draft mixing ribs 1035 (e.g. 6 degree). As shown in FIG. 23, the reverse draft mixing ribs 1035 may transition to different sizes or shapes along the body 1020. For example, a 5 degree reverse draft mixing ribs may transition to a 1 degree reverse draft (e.g., for moldability). As also shown in FIG. 23, the opening 1030 may be concentric with the blade assembly.

In an embodiment, lip 1029 may be configured to operatively mate with the serving lid or serving cup 610, 640 and may be configured to operatively receive a rim 615, 645 (e.g. an inner surface or an outer surface of rims 615, 645) of the serving lid 640 or serving cup 610 when the serving cup 610 is inverted. In an embodiment, lip 1039 may be configured to operatively form a snap-fit or friction fit with the serving lid or serving cup 610, 640 forming a generally liquid tight seal. In an embodiment, lip 1039 may extend annularly from the opening 1030 for a predetermined width. In an embodiment, lip 1029 may further include a terminal end (e.g. perimeter edge 1032 of the lip 1029 of the opening 1030) extending generally coaxially with the body 1020.

In an embodiment, the lip 1029 may extend from the neck 1026 and the spout 034 may extend from the lip 1029 so that the spout 1034 occupies the vertical space above the neck 1026 and lip 1029. In an embodiment, the lip 1029 may extend around an entire circumference of the neck 1026. In an embodiment, the lip 1029 may extend around an entire circumference of the neck 1026 with the spout 1034 extending from a portion of the lip 1029 and the lip having a perimeter or exposed edge 1032 around the remaining portion of the opening 1030 not having the spout 1034. In an embodiment, the perimeter or exposed edge 1032 of the lip 1029 extend into or be flush with the sides of the spout 1034.

As shown in FIG. 22, the body 1020, shoulder 1022, neck 1026, and lip 1029 (not including the spout 1034) may be generally symmetrical with the spout 1034 positioned on top of the lip 1029 and the lip 1029 positioned under or below the spout 1034. As shown in FIG. 23, the body 1020, shoulder 1022, any neck 1026 may be generally symmetrical and the lip 1029 may be asymmetrical as the lip 1029 may extend into the spout 1034 on one side and extend coaxially with the body on the other side above or with the spout 1034.

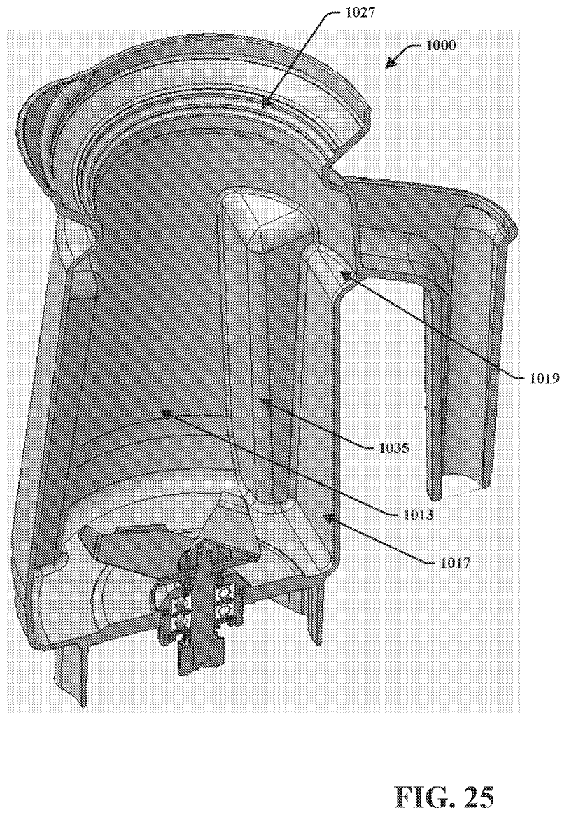

As shown in FIG. 25, the opening 1030 may include one or more concentric ribs 1027 on an interior surface of any of the lip 1029, neck 1026, shoulder 1022, or the like. The ribs 1027, in an embodiment, may not be continuous or may be a patterned surface. The ribs 1027 may interact with or engage either or both the consumer cup 610 or lid 640, or adaptor 700, when operatively couple with the container 1000.

Generally, the container 1000 may be sized and shaped to blend a desired quantity of foodstuff and to receive a consumer cup or lid 610, 640 in lieu of a cover 10, 30 (as described in respect to FIGS. 3-36). The opening 1030 of the container 1000 may generally correspond to the consumer cup or lid so as to form a generally liquid tight seal such that when the container 1000 is rotated to dispense the foodstuff into a cup 610 the liquid portion of the foodstuff does not leak. For example, the circumference 1032 of the opening 1030 may generally correspond to a circumference of the cup or lid so that the cup or lid may engage with or operatively attach to the opening 1030 of the container 1000. In another example, the circumference 1032 of the opening 1030 may be smaller or more narrow than a circumference of the cup or lid so that the cup or lid may be placed or fit over to the opening 1030 of the container 1000. Alternatively, the circumference 1032 of the opening 1030 may be larger or greater than a circumference of the cup or lid so that the cup or lid may be placed snugly within or into to the opening 1030 of the container 1000.

Notably, the container 1000, and circumference 1032 of the opening 1030 thereof, may be able to accommodate each of the above described fittings (engagement with corresponding diameter, loose fitting over the container 1000, snug fitting within the container 1000, etc.) with difference sized and shaped consumer cups or lids. Other diameters of the container 1000 may also be provided to accommodate different sized cups or lids, or other containers, such as bowls, etc.

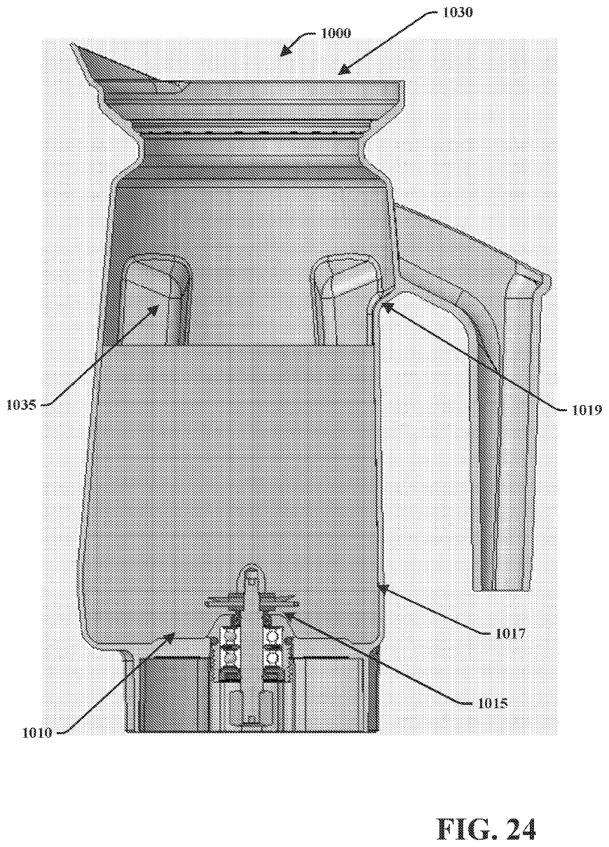

FIGS. 24-32 show various embodiments of container 1000 having a body 1020 with symmetrical and asymmetrical sides. As shown in FIGS. 22-23, container 1000 may have a body 1020 with four (or all) symmetrical side walls. In an example, the side walls may generally extend from the base 1010 up to shoulder 1022 or neck 1026 or including the shoulder 1022 or neck 1026 (e.g. not including the handle 1036, lip 1029, or spout 1034).

As shown in FIGS. 24-32, container 1000 may have a body 1020 that includes at least two generally symmetrical sides 1013, and at least one non-symmetrical side 1017. In an embodiment, the body 1020 may include at least two symmetrical sides 1013. In an embodiment, the body 1020 may include two or more symmetrical sides. In an embodiment, the body 1020 may include at least one non-symmetrical side 1017. In an embodiment, the sides of the at least two generally symmetrical sides 1013 and the at least one non-symmetrical side 1017 may be bound by one or more ribs 1035 extending from the closed end 1010 to the open end 1030.

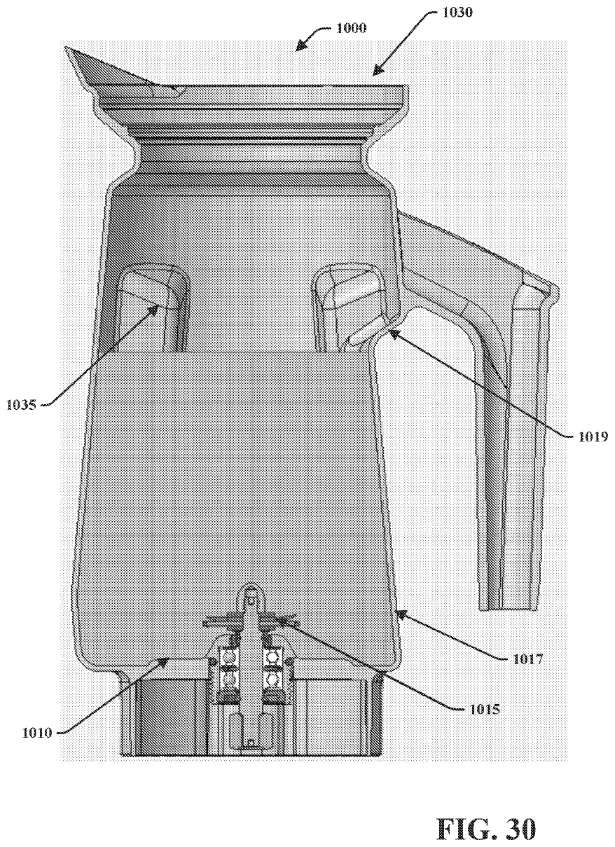

As shown in FIGS. 24-29, the at least one non-symmetrical side 1017 may be generally planar or flat. As shown in FIGS. 30-32, the at least one non-symmetrical side 1017 may be curved. In an embodiment, the non-symmetrical side 1017 may comprise a first arc having a first radius. As shown in FIGS. 24-32, the at least two generally symmetrical sides 1013 may be curved. In an embodiment, the at least two generally symmetrical sides 1013 may comprise a second arc having a second radius. In an embodiment, the first radius of the at least one non-symmetrical side 1017 may be smaller than the second radius of the at least two generally symmetrical sides 1013. It is noted that the first radius of the at least one non-symmetrical side 1017 may be larger than the second radius of the at least two generally symmetrical sides 1013.

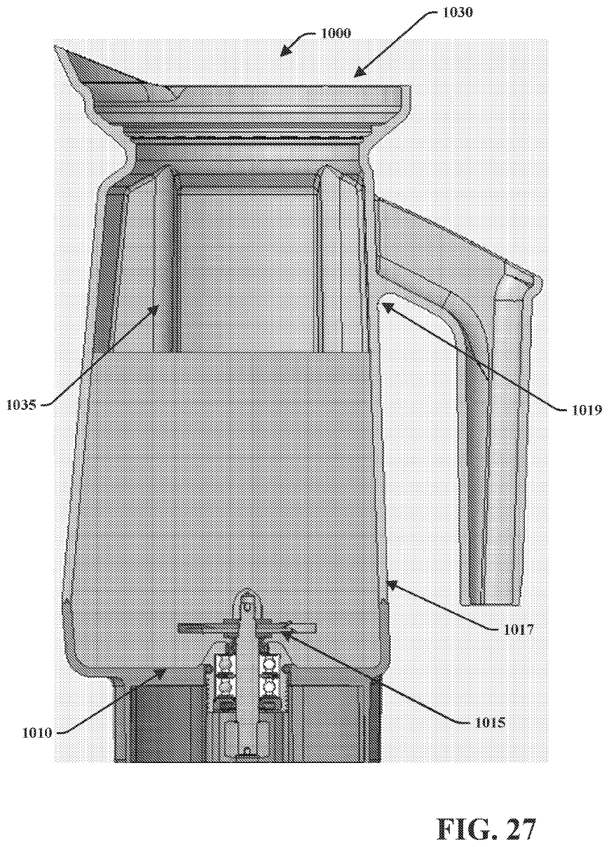

In an embodiment, the container 1000 may further comprise a handle 1036 extending from the at least one non-symmetrical side 1017. In an embodiment, the at least one non-symmetrical side 1017 may be indented relative the handle 1036, providing a straight, indented side 1071 and a rounded shape or undercut 1019 extending from the side 1017 of the container 1000 into the underside of the handle 1036 shown in FIGS. 24-26. In an embodiment, the at least one non-symmetrical side 1017 may be generally straight relative the handle 1036, providing a flat, straight side 1071 and a flat profile 1019 relative the handle 1036 shown in FIGS. 27-29. In an embodiment, the at least one non-symmetrical side 1017 may progressively indent towards the container 1000 as the side 1017 extends to and reaches the handle 1036, providing a tapered, indented side 1071 and a rounded shape or undercut 1019 extending from the side 1017 of the container 1000 into the underside of the handle 1036 shown in FIGS. 30-32.

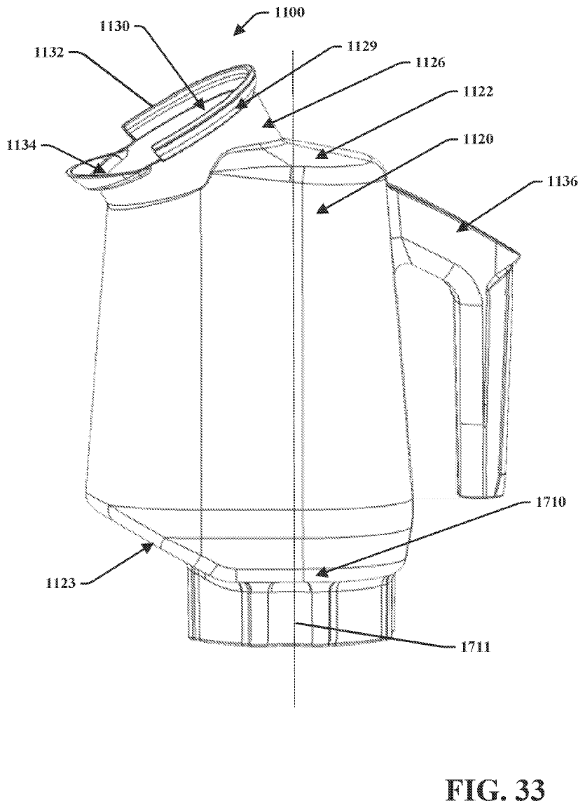

FIGS. 33-36 show embodiments of a container 1100. Container 1100 may comprise an open body 1120 configured to receive and hold foodstuff. The body may include a blade assembly (130, for example) at its base 1110. The blade assembly and base 1110 of the container 1100 may be configured to operatively couple to a blender base, such as blender base 110 shown in FIG. 1 or blender enclosure shown in FIG. 15.

The body 1120 of the container 1100 may further comprise a shoulder 1122, a neck 1126, and a lip 1129. The lip 1129 may have a perimeter edge 1132 and define an opening 1130. The opening 1130 may further include a spout 1134. The lip 1129 and spout 1134 may be similar to lip 929 and spout 934 shown in FIGS. 20-21. The lip 1129 may be configured to operatively mate with the serving cup 610 or serving lid 640. The body 1120 may further include one or more ribs to facilitate, for example, mixing of foodstuff during a blending operation. It is noted that container 1100 may include no mixing ribs in some embodiments. The body may further include a handle 1136 to facilitate, for example, positioning of the container 1100 and pouring of the blended contents, e.g., through tilting or inversion of the container 1100.

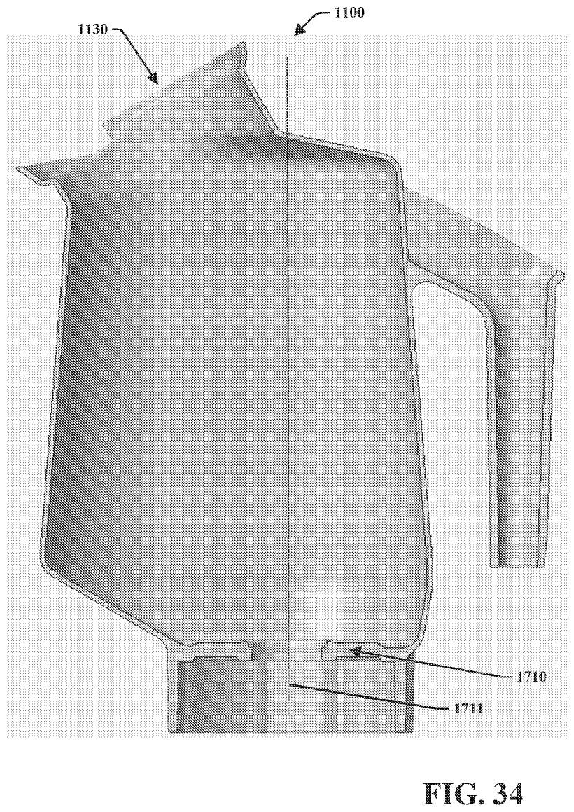

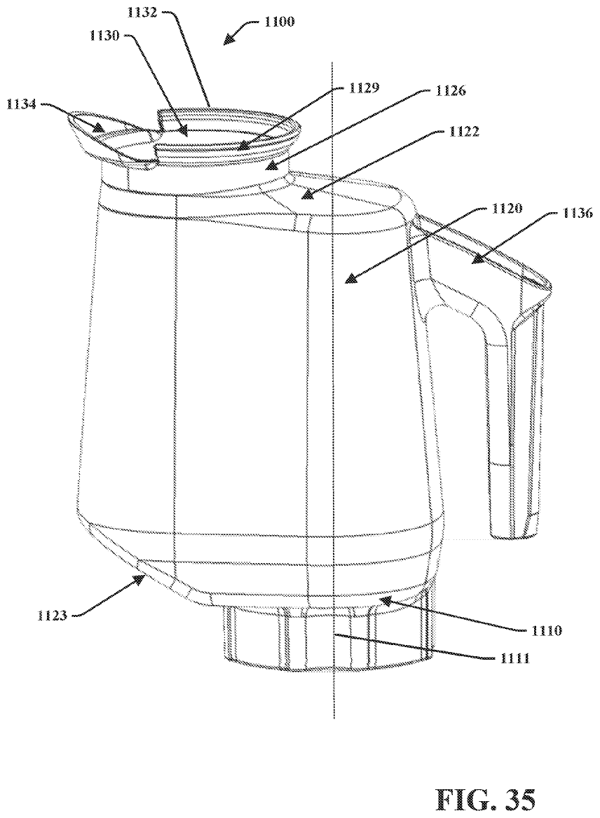

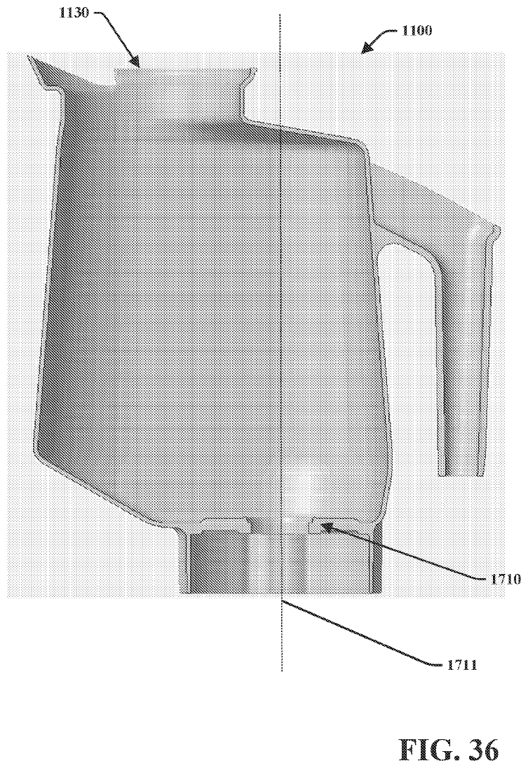

As shown in FIGS. 33-36, opening 1130 may be offset from the base 1110 or blade assembly (see blade axis 1111). The shoulder 1122 may be elongated or extended on one side of the neck 1126 or opening 1130, such as on the side that is directly above or over the base 1130 or blade axis 1111. The extension of the opening 1130 to be offset from the base 1130 or blade axis 1111 may further result in a step-out portion 1123 extending from the base 1110 and to the body 1120 of the container. In an embodiment, the opening 1130 may be upright as shown in FIGS. 35-36 or angled as shown in FIGS. 33-34. In an embodiment, the opening 1130 may be angled approximately 45 degrees from the body 1120. The handle 1136 may attach at a single point to the body 1120 of the container 1100 and may be an ascent-type handle. In an example, the container 1100 may comprise a reverse draft body (e.g. 5 degree) and no mixing ribs.

Generally, the container 1100 may be sized and shaped to blend a desired quantity of foodstuff and to receive a consumer cup or lid 610, 640 in lieu of a cover 10, 30 (as described in respect to FIGS. 3-36). The opening 1130 of the container 1100 may generally correspond to the consumer cup or lid. For example, the circumference 1132 of the opening 1130 may generally correspond to a circumference of the cup or lid so that the cup or lid may engage with or operatively attach to the opening 1130 of the container 1100. In another example, the circumference 1132 of the opening 1130 may be smaller or more narrow than a circumference of the cup or lid so that the cup or lid may be placed or fit over to the opening 1130 of the container 1100. Alternatively, the circumference 1132 of the opening 1130 may be larger or greater than a circumference of the cup or lid so that the cup or lid may be placed snugly within or into to the opening 1130 of the container 1100.

Notably, the container 1100, and circumference 1132 of the opening 1130 thereof, may be able to accommodate each of the above described fittings (engagement with corresponding diameter, loose fitting over the container 1100, snug fitting within the container 1100, etc.) with difference sized and shaped consumer cups or lids. Other diameters of the container 1100 may also be provided to accommodate different sized cups or lids, or other containers, such as bowls, etc.

Disclosed is a method for using a blending system and serving blended foodstuff. The method may include inserting foodstuff into a blending container through an open end of the blending container. The method may include covering at least a portion of the open end of the blending container with a serving cup or serving lid, or by positioning the container into an enclosure. The method may include actuating the blending system and blending the foodstuff. The method may include transferring the blended foodstuff from the blending container into the serving cup. The method may include removing the serving cup from the open end of the blending container prior to transferring the blended foodstuff from the blending container into the serving cup. The method may include rotating the blending container and the serving cup to transfer the blended foodstuff from the blending container into the serving cup. The rotation of the blending container and the serving cup may occur simultaneously and without separating the blending container and the serving cup.

It is noted that any of the described containers herein may include mating aspects, such as a neck, perimeter edge, and/or lip which are configured to engage with a rim or lip of a consumer lid or cup. The opening of the container may generally correspond to the consumer lid or cup so as to form a generally liquid tight seal such that when the container 1000 is rotated to dispense the foodstuff into a cup 610 the liquid portion of the foodstuff does not leak. An interior surface and/or exterior surface of the opening, neck, perimeter edge, and/or lip of the container may interact with an interior surface and/or exterior surface of the opening or rim of the consumer lid or cup. The consumer cup may generally be inverted and the consumer lid may be kept upright to serve as a cover to the containers during a blending process. In an embodiment, the open end of the container may be configured to be partially or fully covered by the consumer lid or consumer cup during blending of foodstuff. The consumer lid or cup may be used during a blending process as a cover for the container and may be used to receive or serve blended foodstuff from the container to the consumer.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A blending container, comprising:
a body forming a cavity, the body comprising:
a closed end comprising a blade assembly, wherein the closed end is configured to operatively couple to a motor base; and
an open end opposite the closed end, and comprising a perimeter edge defining an opening, wherein at least a portion of the perimeter edge is configured to operatively receive a serving lid or a serving cup when the closed end is operatively coupled to the motor base.

2. The blending container of claim 1, wherein the perimeter edge of the open end further comprises a lip configured to operatively mate with the serving lid or the serving cup.

3. The blending container of claim 2, wherein the lip is configured to operatively form a snap-fit or friction fit with the serving lid or the serving cup.

4. The blending container of claim 2, wherein the lip extends annularly from the opening for a predetermined width, and wherein the lip is configured to operatively receive a rim of the serving lid or the serving cup when the serving cup is inverted.

5. The blending container of claim 4, wherein the lip further includes a terminal end extending generally coaxially with the body.

6. The blending container of claim 1, wherein the open end includes a neck disposed between the open end and the closed end.

7. The blending container of claim 6, wherein the body tapers inwardly towards the neck from the closed end.

8. The blending container of claim 7, wherein an outer surface of the neck is configured to operatively engage with the serving lid or the serving cup.

9. The blending container of claim 1, wherein the body further comprises at least two generally symmetrical sides, and at least one non-symmetrical side.

10. The blending container of claim 9, wherein the at least two generally symmetrical sides and the at least one non-symmetrical side are bound by one or more ribs extending from the closed end to the open end.

11. The blending container of claim 9, further comprising a handle extending from the at least one non-symmetrical side.

12. The blending container of claim 9, wherein the at least one non-symmetrical side is generally planar.

13. The blending container of claim 9, wherein the at least one non-symmetrical side comprises a first arc having a first radius, and the at least two generally symmetrical sides comprise a second arc having a second radius, wherein the first radius is smaller than the second radius.

14. A blending container, comprising:
a body forming a cavity, and comprising a bottom wall defining a closed end, an open end defining an opening, and at least one side wall extending from the closed end to the open end;
wherein the bottom wall is couplable to a blade assembly and configured to operatively couple to a motor base; and
wherein a perimeter of the bottom wall is larger than a portion of the body between the open end and the closed end, and wherein the open end includes a surface for receiving at least one of a serving cup lid or an inverted serving cup.

15. The blending container of claim 14, wherein the blending container does not include a lid.

16. The blending container of claim 14, wherein the open end of the blending container further comprises a lip configured to operatively mate at least one of the serving cup lid or the inverted serving cup, wherein the lip extends annularly from the opening for a predetermined width.

17. The blending container of claim 14, wherein the blending container is configured to insert into an enclosure and carry out a blending operation without the serving cup lid or the inverted serving cup.

18. The blending container of claim 14, wherein the surface of the open end is configured to operatively receive varying sizes of serving lids or inverted serving cups.

19. A blending system, comprising:
a motor base,
a container comprising a body forming a cavity and configured to operatively couple to the motor base at a closed end of the container, the closed end comprising a blade assembly, wherein the container comprises an open end opposite the closed end and is configured to receive foodstuff into the cavity; and
a serving cup or serving lid configured to operatively couple with the open end of the container, wherein the open end of the container is configured to be partially or fully covered by the serving lid or the serving cup during blending of the foodstuff.

20. A method for using a blending system and serving blended foodstuff, the method comprising:
inserting foodstuff into a blending container through an open end of the blending container;
covering at least a portion of the open end of the blending container with a serving cup or an enclosure;
actuating the blending system and blending the foodstuff; and
transferring the blended foodstuff from the blending container into the serving cup.

21. The method of claim 20, further including removing the serving cup from the open end of the blending container prior to transferring the blended foodstuff from the blending container into the serving cup.

22. The method of claim 20, further including rotating the blending container and the serving cup to transfer the blended foodstuff from the blending container into the serving cup.
